(19) United States
(12) Patent Application Publication
(10) Pub. No.: US 2025/0199158 A1
(43) Pub. Date: Jun. 19, 2025

(54) INTEGRATED LIDAR AND RADAR SYSTEM

(71) Applicant: Luminar Technologies, Inc., Orlando, FL (US)

(72) Inventors: Jason M. Eichenholz, Orlando, FL (US); Philip W. Smith, Melbourne, FL (US); Roger S. Cannon, Oviedo, FL (US); Christopher Gary Sentelle, Orlando, FL (US)

(21) Appl. No.: 18/977,241

(22) Filed: Dec. 11, 2024

Related U.S. Application Data
(60) Provisional application No. 63/610,763, filed on Dec. 15, 2023.

(51) Int. Cl. G01S 13/86; G01S 7/481; G01S 13/42

(52) U.S. Cl. CPC G01S 13/865; G01S 7/4817; G01S 13/426

(57) ABSTRACT

A system comprises a light source, a radar transmitter, a light receiver, a radar receiver, and a processor. The light source is configured to emit a light pulse. The radar transmitter is configured to transmit a radar signal, wherein an emission direction of the light pulse of the light source and a transmission direction of the radar signal of the radar transmitter are at least in part synchronized. The light receiver is configured to detect a reflected light pulse, the radar receiver is configured to detect a reflected radar signal, and the processor is configured to determine a dimensional representation of an environment based at least in part on the detected reflected light pulse and the detected reflected radar signal.

### CROSS REFERENCE TO OTHER APPLICATIONS

This application claims priority to U.S. Provisional Patent Application No. 63/610,763 entitled INTEGRATED LIDAR AND RADAR SYSTEM filed Dec. 15, 2023 which is incorporated herein by reference for all purposes.

### BACKGROUND OF THE INVENTION

Light detection and ranging (lidar) and radio detection and ranging (radar) are technologies that can be used to measure distances to remote targets. Typically, a lidar system includes a light source and an optical receiver and a radar system includes a radar frequency (RF) source and a radar receiver. The light source of a lidar system can include, for example, a laser which emits light having a particular operating wavelength. The operating wavelength of a lidar system may lie, for example, in the infrared, visible, or ultraviolet portions of the electromagnetic spectrum. The light source emits light towards a target which scatters the light, and some of the scattered light is received back at the lidar receiver. The lidar system determines the distance to the target based on one or more characteristics associated with the received light. For example, the lidar system may determine the distance to the target based on the time of flight for a pulse of light emitted by the light source to travel to the target and back to the lidar system. The RF source of a radar system emits RF signals towards a target which scatters the RF signals. Some of the scattered RF signals are received back at the radar receiver. The radar system determines the distance of a target based on reflected RF signals.

### BRIEF DESCRIPTION OF THE DRAWINGS

Various embodiments of the invention are disclosed in the following detailed description and the accompanying drawings.

FIG. 1A illustrates an example integrated light detection and ranging (lidar) and radio detection and ranging (radar) system.

FIG. 1B illustrates an example integrated lidar and radar system.

FIG. 2 illustrates an example scan pattern produced by the lidar components of an example integrated lidar and radar system.

FIG. 3 illustrates an example integrated lidar and radar system with an example rotating polygon mirror.

FIG. 4 illustrates an example light-source field of view (FOVL) and receiver field of view (FOVR) for an example integrated lidar and radar system.

FIG. 5 illustrates an example unidirectional scan pattern that includes multiple pixels and multiple scan lines.

FIG. 6 illustrates an example integrated lidar and radar system with a light source that emits pulses of light and local-oscillator (LO) light.

FIG. 7 illustrates an example laser receiver of an example integrated lidar and radar system and an example voltage signal corresponding to a received pulse of light.

FIG. 8 illustrates an embodiment of a dual mode scanner of an integrated lidar and radar system.

FIG. 9 illustrates an embodiment of a dual mode scanner of an integrated lidar and radar system.

FIG. 10 illustrates an embodiment of a dual mode scanner of an integrated lidar and radar system.

FIG. 11 illustrates an embodiment of a mirror component for a dual mode scanner of an integrated lidar and radar system.

FIG. 12 illustrates an embodiment of an integrated light detection and ranging (lidar) and radio detection and ranging (radar) system.

FIG. 13 illustrates an example computer system 1300.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

An integrated light detection and ranging (lidar) and radio detection and ranging (radar) system is disclosed. For example, using the disclosed integrated lidar and radar system, both light beams and radio frequency (RF) signals are emitted to scan one or more fields of regard. A scanned field of regard using light beams can be the same, different, or overlapping field of regard as the scanned field of regard using RF signals. In some embodiments, the different fields of regard overlap along one or more axes. For example, in the context of a vehicle equipped with the disclosed integrated lidar and radar system, the radar can be directed to scan downwards towards the road surface directly in front of the vehicle with a limited range in elevation while a corresponding lidar of the same integrated lidar and radar system can be directed to scan ahead of the vehicle with a large range in elevation that includes the horizon. As another example, the lidar can be directed to scan primarily ahead of the vehicle while the radar can be directed to scan regions that include the peripheries of the vehicle.

In some embodiments, the disclosed integrated lidar and radar system utilizes dual mode elements such as a shared processor and/or a dual mode scanner to allow for integrated detection and ranging using both light pulses and RF signals. For example, a shared processor can be used to process detected light pulse and RF signal reflections and to fuse the processed measurements. By processing lidar and radar measurements together in a synchronized and coupled manner, the processing can more easily and with reduced processing requirements address range wrap issues such as matching emitted light pulses with detected reflections. Additionally, the detection and ranging accuracy of the integrated system is significantly improved since both lidar and radar components can be operated with a higher tolerance to noise. For example, when operated in fog, radar can continue to penetrate through the fog even when lidar can be impacted by the fog due to increased noise such as back scatter from fog. When integrated together using the disclosed integrated lidar and radar system, the integrated radar can provide an initial view of the surrounding environment and function as a source of validation for results from the integrated lidar. The results from the integrated lidar, once validated with radar readings, can provide a more accurate scan of the environment than can be made with radar alone. The use of dual mode measurements from an integrated system allows signals that would otherwise be discarded as potential noise to be confirmed as accurate measurements corresponding to downrange objects.

In various embodiments, the coupled lidar and radar signals allow for processing of related signals earlier in the processing pipeline, resulting in significant improvements in the resulting measurements. The earlier correlation of related signals allowed by the disclosed inventions provides opportunities for refinement that allow for improved results such as increased resolution and higher accuracy, including with reduced processing power. For example, in scenarios where radar excels, initial radar results can be used to refine and/or disambiguate corresponding lidar results. Additionally, the initial results from one source can be used for cross-modal refinement to improve the subsequent detection results of the other source, such as by adjusting power usage, thresholds, and scan areas. For example, the power used for lidar can be increased or decreased depending on radar measurements, and the thresholds used to detect valid measurements can be similarly adjusted. Additional passes over a refined area or region can be performed much earlier than with decoupled systems, such as where fusion of lidar and radar data is performed after a lidar point cloud is generated. In contrast, the refinement process using the disclosed inventions can be performed earlier and iteratively such as on selective and identified dedicated regions of interest over a configurable number of passes. This cross-modal approach applies to all supported modalities, including scenarios where lidar excels over radar. When one modality excels for a particular region of interest, the region can be rescanned with adjusted configuration parameters such as increased power and modified threshold values based on sensor measurements from the modality that is initially found to be more accurate.

In various embodiments, the improved accuracy of the disclosed integrated lidar and radar system allows the lidar and radar functionality to each operate with a higher tolerance to noise. For example, when operated in fog, radar can continue to penetrate through the fog even when lidar can be impacted by the fog due to increased noise such as back scatter from fog. When integrated using the disclosed integrated lidar and radar system, the integrated radar can provide an initial view of the surrounding environment and function as a source of validation for results from the integrated lidar. The results from the integrated lidar, once validated with radar readings, can provide a more accurate scan of the environment than can be made with radar alone.

In some embodiments, the disclosed integrated lidar and radar system includes a dual mode scanner that can function to perform scanning for both lidar and radar purposes. For example, a dual mode scanner can include one or more shared scanning mirrors that allow the light pulses and RF signals to be coupled along one or more axes. In some embodiments, the emitted light pulses and RF signals can be reflected off the same or different facets of a polygon mirror of the dual mode scanner to direct the corresponding emitted light pulses and RF signals at synchronized azimuth angles. Similarly, the emitted light pulses and RF signals can be reflected off the same scanning mirror to direct the corresponding emitted light pulses and RF signals at synchronized elevation angles. In some embodiments, although the lidar and radar measurements are synchronized, they may be decoupled along one or more axes. For example, a scanning mirror can couple the light pulses and RF signals at synchronized azimuth angles and a corresponding elevation scanning mirror that is reflective for light but transmissive to RF signals can decouple the light pulses from the RF signal to direct each at different elevation angles. In particular embodiments, the mechanical steering performed by the dual mode scanner is combined with electronic steering. For example, by combining mechanical and electronic scanning techniques, the lidar and radar elements can be coupled along some axes and controlled independently along other decoupled axes. In some embodiments, light pulses and RF signals are coupled at synchronized azimuth angles but decoupled in elevation. For example, the light pulses can be scanned in elevation using a scanning mirror transmissive to RF signals and the RF signals can be electronically scanned in elevation.

In various embodiments, different scanning configurations of the dual mode scanner are appropriate and the different configurations allow different results to be achieved. Although the light pulses and RF signals may be coupled or decoupled for different axes, the corresponding light and RF sources can be synchronized with respect to timing. For example, the emitted light pulses and corresponding transmitted RF signals can be configured to exit the disclosed integrated lidar and radar system within a small transmission window, such as within nanoseconds of one another. The ability to synchronize the lidar and radar functionality, in both time and space, allows the resulting detection and ranging measurements to be analyzed together. The processing can be performed early in the perception processing pipeline allowing for improved accuracy with reduced computational resource, hardware, and power requirements. The results of the disclosed integrated lidar and radar system are highly accurate fused measurements and the ability to generate a corresponding precise and unified point cloud, including 3D and/or 4D point clouds, from the fused measurements.

In some embodiments, an integrated lidar and radar system comprises a light source, a radar transmitter, a light receiver, a radar receiver, and a processor. For example, the integrated lidar and radar system performs both lidar and radar functionality with one or more dual mode elements, such as a processor and/or a dual mode scanner, that function for both lidar and radar purposes. In some embodiments, the light source is configured to emit a light pulse. For example, a light source can emit light pulses having one or more particular operating wavelengths. In some embodiments, the radar transmitter is configured to transmit a radar signal, wherein an emission direction of the light pulse of the light source and a transmission direction of the radar signal of the radar transmitter are at least in part synchronized. For example, a transmitted radar signal and an emitted light pulse can be coupled along one or more axes, such as directing the radar signal and light pulse to be synchronized along the same azimuth and/or elevation. In some embodiments, the lidar and radar are synchronized partially (along one axis) or more completely (along multiple axes) using a dual mode scanner. The dual mode scanner can include one or more mirrors including mirrors that reflect both light beams and RF signals as well as mirrors that reflect one but are transmissive to another, such as reflective for light pulses but transmissive for radar signals. In various embodiments, the synchronization of the transmitted radar signal and the emitted light includes synchronizing the timing of their transmission and/or reception. For example, the transmission of the radar signal and light pulse can be performed within nanoseconds of one another.

In some embodiments, the light receiver of the integrated lidar and radar system is configured to detect a reflected light pulse and the radar receiver of the integrated lidar and radar system is configured to detect a reflected radar signal. For example, a light receiver of the integrated lidar and radar system detects reflected light pulses from downrange objects and the radar receiver of the integrated lidar and radar system detects reflected radar signals of the same or different downrange objects. In some embodiments, the processor is configured to determine a dimensional representation of an environment based at least in part on the detected reflected light pulse and the detected reflected radar signal. For example, measurements outputted by corresponding light and RF detectors for the received reflections can be processed using the same processor to create a dimensional representation of the surrounding environment. In some embodiments, the dimensional representation corresponds to a point cloud and/or feature map of the surrounding environment.

In various embodiments, in the event the radar and lidar transmissions are at least partially synchronized, the measured values corresponding to the received associated reflections can be fused and, in some embodiments, fused early in a perception processing pipeline. For example, received radar and lidar detection data relating to the same downrange objects can be correlated to create highly accurate and precise object measurements. Moreover, the corresponding lidar and radar measurements of the integrated lidar and radar system can be fused early to generate a highly detailed point cloud particularly for specific regions of interest. Where the lidar and radar measurements do not overlap, such as when their respective transmissions are directed at different fields of regard, the measurements for different radar and lidar fields of regards can be used to generate a larger and more accurate point cloud. For example, the total scanned environment can be expanded and/or specific regions of interest, such as high impact and/or high value regions, can be generated with higher density lidar measurements and lower value regions, such as regions on the periphery, can be generated with lower density radar measurements.

In particular embodiments, by overlapping scanned fields of regards, the measured reflections of synchronized lidar and radar transmissions via integrated lidar and radar components improve the overall accuracy of the detection and ranging system. For example, a corresponding point cloud can be generated with a higher point density by at least in part validating the accuracy of target data using the multiple measurements captured from different sensors. In some embodiments, the ability to fuse radar and lidar measurements allows both radar and lidar components to be operated with higher thresholds for noise. Data that would otherwise be discarded, for example, as potential noise, can be confirmed as valid and accurate measurement data. These advantages are possible through the early fusion of coupled lidar and radar measurements using the disclosed integrated lidar and radar system.

An integrated lidar and radar system operates in a vehicle and includes multiple “eyes,” each of which has its own field of regard, or an angular range over which the eye scans targets using pulses of light and/or radio frequency (RF) signals in accordance with a scan pattern. The fields of regard can combine along a certain dimension (e.g., horizontally) to define the overall field of regard of the integrated lidar and radar system. The integrated lidar and radar system then can use data received via its eyes to generate a point cloud or otherwise process the received data.

In a two-eye configuration of the integrated lidar and radar system, the two eyes can be housed together and scan the respective fields of regard via a shared window or separate windows, or the eyes can be housed separately. In the latter case, an assembly referred to as a “sensor head” can include a scanner (including a dual mode scanner), a laser receiver, and an optical element such as a collimator or a laser diode to generate or convey a beam of light. The assembly further includes radar components to scan radio frequency (RF) signals using the dual mode scanner and a RF receiver and other elements to emit and receive portions of the emitted RF signals.

Depending on the implementation, each eye of an integrated lidar and radar system can include a separate scanner (e.g., each eye can be equipped with a pivotable scan mirror to scan the field of regard vertically and another pivotable scan mirror to scan the field of regard horizontally), a partially shared scanner (e.g., each eye can be equipped with a pivotable scan mirror to scan the field of regard vertically, and a shared polygon mirror can scan the corresponding fields of regard horizontally, using different reflective surfaces), or a fully shared scanner (e.g., a pivotable planar mirror can scan the fields of regard vertically by reflecting incident beams at different regions on the reflective surface, and a shared polygon mirror can scan the corresponding fields of regard horizontally, using different reflective surfaces). Each scanner can function in a dual mode to additionally scan radio frequency (RF) signals (in addition to light pulses or beams of light) as part of a radar system of an integrated lidar and radar system.

Different hardware configurations allow the integrated lidar and radar system to operate the eyes more independently of each other, as is the case with separate scanners, or less independently, as is the case with a fully shared scanner. For example, the two or more eyes may scan the respective fields of regard using similar or different scan patterns. In one implementation, the two eyes trace out the same pattern, but with a certain time differential to maintain angular separation between light-source fields of view and thereby reduce the probability of cross-talk events between the sensor heads. In another implementation, the two eyes scan the corresponding fields of regard according to different scan patterns, at least in some operational states (e.g., when the vehicle is turning right or left). In various embodiments, the scanners, whether separate, fully shared, and/or partially shared, can be dual mode scanners that scan both light pulses and radio frequency (RF) signals using one or more shared elements of the same dual mode scanner. The scan patterns for the light pulses and RF signals scanned via the same dual mode scanner can be similar or different scan patterns.

Further, according to one approach, two eyes of an integrated lidar and radar system are arranged so that the fields of regard of the eyes are adjacent and non-overlapping. For example, each field of regard can span approximately 60 degrees horizontally and 30 degrees vertically, so that the combined field of regard of the integrated lidar and radar system spans approximately 120 degrees horizontally and 30 degrees vertically. The corresponding scanners (or paths within a shared scanner) can point away from each other at a certain angle, for example, so that the respective fields of regard abut approximately at an axis corresponding to the forward-facing direction of the vehicle.

Alternatively, the integrated lidar and radar system can operate in a “cross-eyed” configuration to create an area of overlap between the fields of regard. The area of overlap can be approximately centered along the forward-facing direction or another direction, which in some implementations a controller can determine dynamically. In this implementation, the two sensor heads can yield a higher density of scan in the area that generally is more important. In some implementations, the fields of regard in a cross-eyed two-eye configuration are offset from each other by a half-pixel value, so that the area of overlap has twice as many pixels. In general, the fields of regard can overlap angularly or translationally. To reduce the probability of cross-talk events (e.g., the situation when a pulse emitted by the light source associated with the first eye is received by the receiver of the second eye), the integrated lidar and radar system can use output beams with different wavelengths.

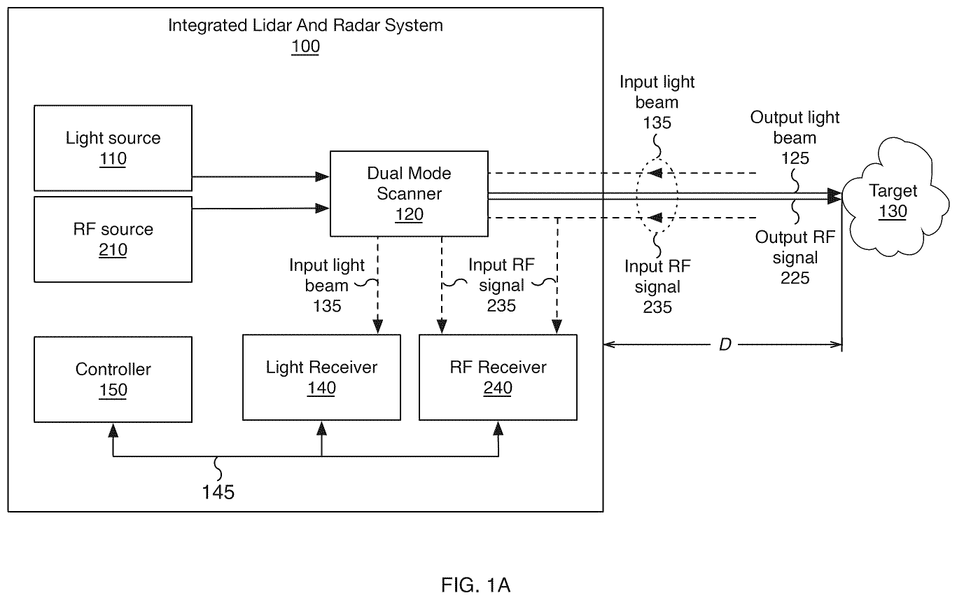

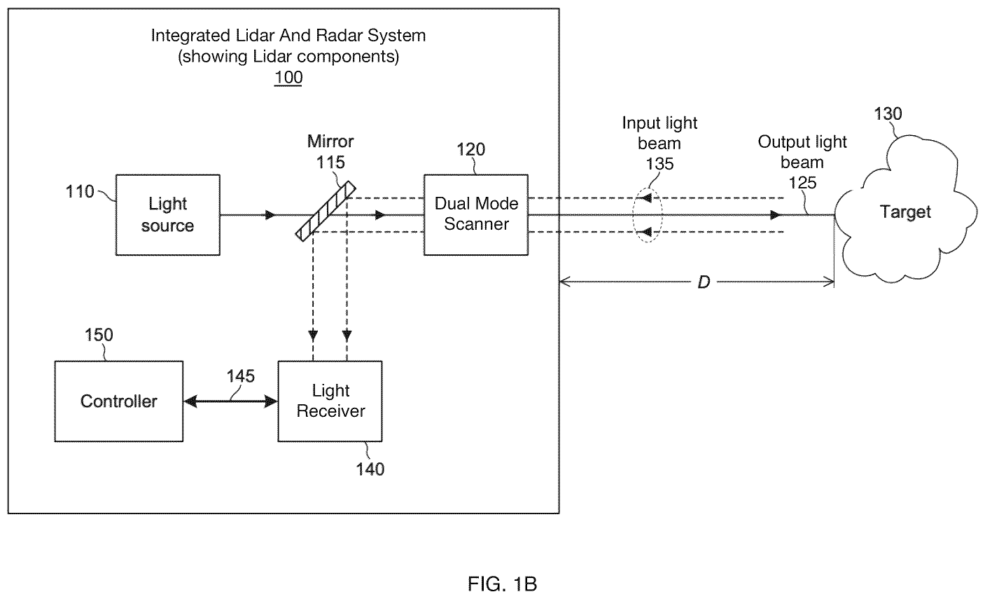

FIG. 1A illustrates an example integrated light detection and ranging (lidar) and radio detection and ranging (radar) system. In particular embodiments, an integrated lidar and radar system 100 may be referred to as a laser ranging system, a laser radar system, a LIDAR system, a lidar sensor, or a laser detection and ranging (LADAR or ladar) system integrated with a radar system, a RADAR system, or a radio detection and ranging (RADAR or radar) system. In particular embodiments, the integrated lidar and radar system 100 of FIG. 1A includes light source 110, radio frequency (RF) source 210, dual mode scanner 120, light receiver 140, radio frequency (RF) receiver 240, and controller 150. Light source 110 emits light pulses to dual mode scanner 120 and RF source 210 transmits RF signals to dual mode scanner 120. Dual mode scanner 120 scans at least a portion of the received light pulses and radio frequency (RF) signals as output light beam 125 and output radio frequency (RF) signal 225, respectively, at one or more fields of regard that can include target 130. The reflections of output light beam 125 and output RF signal 225 from target 130 are received at dual mode scanner 120 as input light beam 135 and input radio frequency (RF) signal 235, respectively. Dual mode scanner 120 directs received input light beam 135 to light receiver 140 and received input RF signal 235 to RF receiver 240. In some embodiments, received input RF signal 235 is received along a separate receive path and does not pass through dual mode scanner 120 on its way to RF receiver 240. FIG. 1A shows both alternate paths (which may not necessarily be exclusive to one another). For example, integrated lidar and radar system 100 may utilize a hybrid approach with one or more RF receivers located along a different return path as dual mode scanner 120 with RF receiver 240 and/or at least one or more RF antennas of RF receiver 240 located at a different location compared to RF source 210. Controller 150 coordinates and communicates with light receiver 140 and RF receiver 240 to processes the detected light and RF reflections and their corresponding measurements. In various embodiments, additional components of integrated lidar and radar system 100 may exist but for the purposes of clarity are not shown in FIG. 1A. For example, various lidar components of integrated lidar and radar system 100 are shown and described in further details herein, and in particular with respect to FIGS. 1B-7.

As shown in FIG. 1A, integrated lidar and radar system includes elements for both lidar and radar functionality among which are dual mode elements such as dual mode scanner 120 and controller 150. For example, dual mode scanner 120 scans both light pulses emitted from light source 110 and RF signals transmitted by RF source 210. In various embodiments, dual mode scanner 120 can couple the received light and RF sources to synchronize their output as output light beam 125 and output RF signal 225. In various embodiments, output light beam 125 and output RF signal 225 can be synchronized in both time and space. For example, the transmission of output light beam 125 and output RF signal 225 can be synchronized such that corresponding light pulses and RF signals of output light beam 125 and output RF signal 225, respectively, are transmitted within nanoseconds of one another. Similarly, output light beam 125 and output RF signal 225 can be directed to scan the same field of regard, for example, to capture both lidar and radar measurements of target 130. In some embodiments, at least one or more axes of output light beam 125 and output RF signal 225 are coupled. For example, output light beam 125 and output RF signal 225 can be configured to scan the same, different, or overlapping fields of regard.

In some embodiments, light source 110 and radio frequency (RF) source 210 are sources for light pulses and RF signals, respectively, used to determine measurements of downrange objects such as target 130. For example, using light pulses emitted by light source 110 and RF signals transmitted by RF source 210, the distance D from integrated lidar and radar system 100 to target 130 can be determined. In some embodiments, RF source 210 corresponds to an array, a phased array, or another appropriate RF source. For example, in some embodiments, RF source 210 corresponds to a phased array RF source that can be electronically steered along with the configured mechanical steering performed by dual mode scanner 120.

In some embodiments, dual mode scanner 120 is a scanner that functions to scan both light pulses and radio frequency (RF) signals across one or more fields of regard. For example, dual mode scanner 120 controls the scanned fields of regard with respect to both lidar and radar with elements that allow the light and RF sources to be partially or fully coupled. In some embodiments, scanning performed by dual mode scanner 120 utilizes one or more scanning mirrors including one or more polygon and/or LATM mirrors for directing the azimuth and elevation angles of output light beam 125 and output radio frequency (RF) signal 225. In particular embodiments, the included scanning mirrors may be configured to couple light pulses and RF signals by reflecting both light and RF frequency signals or to decouple light pulses and RF signals by reflecting light and transmitting RF frequency signals. In some embodiments, the coating and/or materials of the mirror can be configured to focus and/or reflect light and RF signals differently. For example, a polygon with flat optical facets, but containing curved metallic surfaces within, can enable focusing and/or modifying the divergence of the radar beam. Based on the configuration of dual mode scanner 120, different and potentially overlapping lidar and radar fields of regard can be scanned when directing output light beam 125 and output radio frequency (RF) signal 225 from integrated lidar and radar system 100.

Once output light beam 125 and output radio frequency (RF) signal 225 reach the downrange target 130, the target 130 may scatter or reflect at least a portion of light from the output light beam 125 and at least a portion of the RF signal from output RF signal 225, and some of the scattered or reflected light and/or RF signal may return toward the integrated lidar and radar system 100. In the example of FIG. 1A, the scattered or reflected light is represented by input light beam 135, which passes through dual mode scanner 120 and is directed to light receiver 140. As shown in FIG. 1A, the corresponding scattered or reflected RF signal is represented by input radio frequency (RF) signal 235, which may pass through dual mode scanner 120 but is directed to radio frequency (RF) receiver 240. In particular embodiments, a relatively small fraction of the light from output light beam 125 may return to the integrated lidar and radar system 100 as input light beam 135 and, similarly, a relatively small fraction of the RF signal from output RF signal 225 may return to the integrated lidar and radar system 100 as input RF signal 235.

In some embodiments, light receiver 140 is configured to receive or detect photons from input light beam 135 and produce one or more representative lidar signals. For example, the light receiver 140 may produce an output electrical signal 145 that is representative of the input light beam 135, and the electrical signal 145 may be sent to controller 150. Similarly, radio frequency (RF) receiver 240 is configured to receive or detect RF signals from input radio frequency (RF) signal 235 and produce one or more representative radar signals. For example, the RF receiver 240 may produce an output electrical signal 145 that is representative of the input RF signal 235, and the electrical signal 145 may be sent to controller 150. In particular embodiments, light receiver 140, RF receiver 240, and/or controller 150 may include a processor, computing system (e.g., an ASIC or FPGA), or other suitable circuitry. A controller 150 may be configured to analyze one or more characteristics including lidar and radar values of the electrical signal 145 from the light receiver 140 and/or RF receiver 240 to determine one or more characteristics of the target 130, such as its distance downrange from the integrated lidar and radar system 100. This may be done, for example, by analyzing a time of flight or a frequency or phase of a transmitted output light beam 125, a transmitted output radio frequency (RF) signal 225, a received input light beam 135, and/or a received input RF signal 235. If integrated lidar and radar system 100 measures a time of flight of T (e.g., T represents a round-trip time of flight for an emitted pulse of light or RF signal to travel from the integrated lidar and radar system 100 to the target 130 and back to the integrated lidar and radar system 100), then the distance D from the target 130 to the integrated lidar and radar system 100 may be expressed as D=c·T/2, where c is the speed of light (approximately 3.0×10⁸ m/s). In particular embodiments, a distance D from integrated lidar and radar system 100 to a target 130 may be referred to as a distance, depth, or range of target 130. In some embodiments, light receiver 140 and/or RF receiver 240 utilize signals from the other respective component in determining measurements. For example, in various embodiments, light receiver 140 can utilize electrical signal 145 from RF receiver 240 and/or RF receiver 240 can utilize electrical signal 145 from light receiver 140.

In various embodiments, controller 150 fuses measurements provided by light receiver 140 and radio frequency (RF) receiver 240 to create a unified result. For example, measurements corresponding to the same target 130 can be correlated and fused by controller 150. In some embodiments, the provided measurements are used to determine which among a series of detected reflections to associate with a source light pulse or RF signal. For example, range warp issues can be resolved using together the measurements provided by light receiver 140 and RF receiver 240. In various embodiments, the measurements provided by light receiver 140 and RF receiver 240 to controller 150 correspond to electrical signal 145. The process of associating and fusing measurements from light receiver 140 and RF receiver 240 can correspond to a fusion step performed early in a perception pipeline for creating a dimensional representation of the surrounding and/or scanned environment. For example, early fused measurements determined by controller 150 can be used to construct a highly detailed point cloud and/or feature map of the surrounding environment.

In some embodiments, integrated lidar and radar system 100 may include a telescope, one or more lenses, one or more mirrors, and/or other lidar and/or radar elements (not shown). These additional components can be used, for example, to configure integrated lidar and radar system 100 to direct, expand, focus, collimate, or otherwise manipulate output light beam 125, output radio frequency (RF) signal 225, input light beam 135, and/or input radio frequency (RF) signal 235 as desired. As an example, the integrated lidar and radar system 100 may include one or more lenses to focus the input light beam 135 onto a photodetector of light receiver 140. As another example, the integrated lidar and radar system 100 may include one or more flat mirrors or curved mirrors (e.g., concave, convex, or parabolic mirrors) to steer or focus the output light beam 125, output RF signal 225, the input light beam 135, and/or input RF signal 235.

FIG. 1B illustrates an example integrated lidar and radar system 100. In the example shown, the embodiment of integrated lidar and radar system 100 of FIG. 1B shows primarily the lidar components of the integrated unit and may include light source 110, mirror 115, dual mode scanner 120, light receiver 140, or controller 150. The lidar components of the integrated lidar and radar system 100 are shown to describe the lidar functionality of the integrated lidar and radar system 100. In some embodiments, the integrated lidar and radar system 100 of FIG. 1B is the integrated lidar and radar system 100 of FIG. 1A. Although corresponding radar components of the integrated lidar and radar system 100 exist (as shown in FIG. 1A), they are not shown in FIG. 1B.

In various embodiments, the light source 110 may include, for example, a laser which emits light having a particular operating wavelength in the infrared, visible, or ultraviolet portions of the electromagnetic spectrum. As an example, light source 110 may include a laser with one or more operating wavelengths between approximately 900 nanometers (nm) and 2100 nm. The light source 110 emits an output light beam 125 which may be continuous wave (CW), pulsed, or modulated in any suitable manner for a given application. The output light beam 125 is directed downrange toward a remote target 130. As an example, the remote target 130 may be located a distance D of approximately 1 m to 1 km from the integrated lidar and radar system 100.

Once the output light beam 125 reaches the downrange target 130, the target may scatter or reflect at least a portion of light from the output light beam 125, and some of the scattered or reflected light may return toward the integrated lidar and radar system 100. In the example of FIG. 1B, the scattered or reflected light is represented by input light beam 135, which passes through dual mode scanner 120 and is reflected by mirror 115 and directed to light receiver 140. In particular embodiments, a relatively small fraction of the light from output light beam 125 may return to the integrated lidar and radar system 100 as input light beam 135. As an example, the ratio of input light beam 135 average power, peak power, or pulse energy to output light beam 125 average power, peak power, or pulse energy may be approximately 10⁻¹, 10⁻², 10⁻³, 10⁻⁴, 10⁻⁵, 10⁻⁶, 10⁻⁷, 10⁻⁸, 10⁻⁹, 10⁻¹⁰, 10⁻¹¹, or 10⁻¹². As another example, if a pulse of output light beam 125 has a pulse energy of 1 microjoule (μJ), then the pulse energy of a corresponding pulse of input light beam 135 may have a pulse energy of approximately 10 nanojoules (nJ), 1 nJ, 100 picojoules (pJ), 10 pJ, 1 pJ, 100 femtojoules (fJ), 10 fJ, 1 fJ, 100 attojoules (aJ), 10 aJ, 1 aJ, or 0.1 aJ. In some embodiments, the pulse energy of a pulse of input light beam 135 can at times be as large as the pulse energy of a corresponding pulse of output light beam 125.

In particular embodiments, output light beam 125 may include or may be referred to as an optical signal, output optical signal, emitted optical signal, output light, emitted pulse of light, laser beam, light beam, optical beam, emitted beam, emitted light, or beam. In particular embodiments, input light beam 135 may include or may be referred to as a received optical signal, received pulse of light, input pulse of light, input optical signal, return beam, received beam, return light, received light, input light, scattered light, or reflected light. As used herein, scattered light may refer to light that is scattered or reflected by a target 130. As an example, an input light beam 135 may include: light from the output light beam 125 that is scattered by target 130; light from the output light beam 125 that is reflected by target 130; or a combination of scattered and reflected light from target 130.

In particular embodiments, light receiver 140 may receive or detect photons from input light beam 135 and produce one or more representative signals. For example, the light receiver 140 may produce an output electrical signal 145 that is representative of the input light beam 135, and the electrical signal 145 may be sent to controller 150. In particular embodiments, light receiver 140 or controller 150 may include a processor, computing system (e.g., an ASIC or FPGA), or other suitable circuitry. A controller 150 may be configured to analyze one or more characteristics of the electrical signal 145 from the light receiver 140 to determine one or more characteristics of the target 130, such as its distance downrange from the integrated lidar and radar system 100. This may be done, for example, by analyzing a time of flight or a frequency or phase of a transmitted beam of light 125 or a received input light beam 135. If integrated lidar and radar system 100 measures a time of flight of T (e.g., T represents a round-trip time of flight for an emitted pulse of light to travel from the integrated lidar and radar system 100 to the target 130 and back to the integrated lidar and radar system 100), then the distance D from the target 130 to the integrated lidar and radar system 100 may be expressed as D=c·T/2, where c is the speed of light (approximately 3.0×10⁸ m/s). As an example, if a time of flight is measured to be T=300 ns, then the distance from the target 130 to the integrated lidar and radar system 100 may be determined to be approximately D=45.0 m. As another example, if a time of flight is measured to be T=1.33 μs, then the distance from the target 130 to the integrated lidar and radar system 100 may be determined to be approximately D=199.5 m. In particular embodiments, a distance D from integrated lidar and radar system 100 to a target 130 may be referred to as a distance, depth, or range of target 130. As used herein, the speed of light c refers to the speed of light in any suitable medium, such as for example in air, water, or vacuum. As an example, the speed of light in vacuum is approximately 2.9979×10⁸ m/s, and the speed of light in air (which has a refractive index of approximately 1.0003) is approximately 2.9970×10⁸ m/s.

In particular embodiments, light source 110 may include a pulsed or CW laser. As an example, light source 110 may be a pulsed laser configured to produce or emit pulses of light with a pulse duration or pulse width of approximately 10 picoseconds (ps) to 100 nanoseconds (ns). The pulses may have a pulse duration of approximately 100 ps, 200 ps, 400 ps, 1 ns, 2 ns, 5 ns, 10 ns, 20 ns, 50 ns, 100 ns, or any other suitable pulse duration. As another example, light source 110 may be a pulsed laser that produces pulses with a pulse duration of approximately 1-5 ns. As another example, light source 110 may be a pulsed laser that produces pulses at a pulse repetition frequency of approximately 80 kHz to 10 MHz or a pulse period (e.g., a time between consecutive pulses) of approximately 100 ns to 12.5 μs. In particular embodiments, light source 110 may have a substantially constant pulse repetition frequency, or light source 110 may have a variable or adjustable pulse repetition frequency. As an example, light source 110 may be a pulsed laser that produces pulses at a substantially constant pulse repetition frequency of approximately 640 kHz (e.g., 640,000 pulses per second), corresponding to a pulse period of approximately 1.56 μs. As another example, light source 110 may have a pulse repetition frequency (which may be referred to as a repetition rate) that can be varied from approximately 200 kHz to 3 MHz. As used herein, a pulse of light may be referred to as an optical pulse, a light pulse, or a pulse.

In particular embodiments, light source 110 may include a pulsed or CW laser that produces a free-space output light beam 125 having any suitable average optical power. As an example, output light beam 125 may have an average power of approximately 1 milliwatt (mW), 10 mW, 100 mW, 1 watt (W), 10 W, or any other suitable average power. In particular embodiments, output light beam 125 may include optical pulses with any suitable pulse energy or peak optical power. As an example, output light beam 125 may include pulses with a pulse energy of approximately 0.01 μJ, 0.1 μJ, 0.5 μJ, 1 μJ, 2 μJ, 10 μJ, 100 μJ, 1 mJ, or any other suitable pulse energy. As another example, output light beam 125 may include pulses with a peak power of approximately 10 W, 100 W, 1 kW, 5 kW, 10 kW, or any other suitable peak power. The peak power (Pₚₑₐₖ) of a pulse of light can be related to the pulse energy (E) by the expression E=Pₚₑₐₖ·Δt, where Δt is the duration of the pulse, and the duration of a pulse may be defined as the full width at half maximum duration of the pulse. For example, an optical pulse with a duration of 1 ns and a pulse energy of 1 μJ has a peak power of approximately 1 kW. The average power (Pₐᵥ) of an output light beam 125 can be related to the pulse repetition frequency (PRF) and pulse energy by the expression Pₐᵥ=PRF·E. For example, if the pulse repetition frequency is 500 kHz, then the average power of an output light beam 125 with 1-μJ pulses is approximately 0.5 W.

In particular embodiments, light source 110 may include a laser diode, such as for example, a Fabry-Perot laser diode, a quantum well laser, a distributed Bragg reflector (DBR) laser, a distributed feedback (DFB) laser, a vertical-cavity surface-emitting laser (VCSEL), a quantum dot laser diode, a grating-coupled surface-emitting laser (GCSEL), a slab-coupled optical waveguide laser (SCOWL), a single-transverse-mode laser diode, a multi-mode broad area laser diode, a laser-diode bar, a laser-diode stack, or a tapered-stripe laser diode. As an example, light source 110 may include an aluminum-gallium-arsenide (AlGaAs) laser diode, an indium-gallium-arsenide (InGaAs) laser diode, an indium-gallium-arsenide-phosphide (InGaAsP) laser diode, or a laser diode that includes any suitable combination of aluminum (Al), indium (In), gallium (Ga), arsenic (As), phosphorous (P), or any other suitable material. In particular embodiments, light source 110 may include a pulsed or CW laser diode with a peak emission wavelength between 1200 nm and 1600 nm. As an example, light source 110 may include a current-modulated InGaAsP DFB laser diode that produces optical pulses at a wavelength of approximately 1550 nm. As another example, light source 110 may include a laser diode that emits light at a wavelength between 1500 nm and 1510 nm.

In particular embodiments, light source 110 may include a pulsed or CW laser diode followed by one or more optical-amplification stages. For example, a seed laser diode may produce a seed optical signal, and an optical amplifier may amplify the seed optical signal to produce an amplified optical signal that is emitted by the light source 110. In particular embodiments, an optical amplifier may include a fiber-optic amplifier or a semiconductor optical amplifier (SOA). For example, a pulsed laser diode may produce relatively low-power optical seed pulses which are amplified by a fiber-optic amplifier. As another example, a light source 110 may include a fiber-laser module that includes a current-modulated laser diode with an operating wavelength of approximately 1550 nm followed by a single-stage or a multi-stage erbium-doped fiber amplifier (EDFA) or erbium-ytterbium-doped fiber amplifier (EYDFA) that amplifies the seed pulses from the laser diode. As another example, light source 110 may include a continuous-wave (CW) or quasi-CW laser diode followed by an external optical modulator (e.g., an electro-optic amplitude modulator). The optical modulator may modulate the CW light from the laser diode to produce optical pulses which are sent to a fiber-optic amplifier or SOA. As another example, light source 110 may include a pulsed or CW seed laser diode followed by a semiconductor optical amplifier (SOA). The SOA may include an active optical waveguide configured to receive a seed optical signal (e.g., pulses of light or CW light) from the seed laser diode and amplify the seed optical signal as it propagates through the waveguide. For example, the seed laser diode may produce relatively low-power seed optical pulses, and the SOA may amplify each seed optical pulse to produce an emitted pulse of light. The optical gain of the SOA may be provided by pulsed or direct-current (DC) electrical current supplied to the SOA. The SOA may be integrated on the same chip as the seed laser diode, or the SOA may be a separate device with an anti-reflection coating on its input facet or output facet. As another example, light source 110 may include a seed laser diode followed by an SOA, which in turn is followed by a fiber-optic amplifier. For example, the seed laser diode may produce relatively low-power seed optical pulses which are amplified by the SOA, and the fiber-optic amplifier may further amplify each of the optical pulses to produce emitted pulses of light.

In particular embodiments, light source 110 may include a direct-emitter laser diode. A direct-emitter laser diode (which may be referred to as a direct emitter) may include a laser diode which produces light that is not subsequently amplified by an optical amplifier. A light source 110 that includes a direct-emitter laser diode may not include an optical amplifier, and the output light produced by a direct emitter may not be amplified after it is emitted by the laser diode. The light produced by a direct-emitter laser diode (e.g., optical pulses, CW light, or frequency-modulated light) may be emitted directly as a free-space output light beam 125 without being amplified. A direct-emitter laser diode may be driven by an electrical power source that supplies current pulses to the laser diode, and each current pulse may result in the emission of an output optical pulse.

In particular embodiments, light source 110 may include a diode-pumped solid-state (DPSS) laser. A DPSS laser (which may be referred to as a solid-state laser) may refer to a laser that includes a solid-state, glass, ceramic, or crystal-based gain medium that is pumped by one or more pump laser diodes. The gain medium may include a host material that is doped with rare-earth ions (e.g., neodymium, erbium, ytterbium, or praseodymium). For example, a gain medium may include a yttrium aluminum garnet (YAG) crystal that is doped with neodymium (Nd) ions, and the gain medium may be referred to as a Nd:YAG crystal. A DPSS laser with a Nd:YAG gain medium may produce light at a wavelength between approximately 1300 nm and approximately 1400 nm, and the Nd:YAG gain medium may be pumped by one or more pump laser diodes with an operating wavelength between approximately 730 nm and approximately 900 nm. A DPSS laser may be a passively Q-switched laser that includes a saturable absorber (e.g., a vanadium-doped crystal that acts as a saturable absorber). Alternatively, a DPSS laser may be an actively Q-switched laser that includes an active Q-switch (e.g., an acousto-optic modulator or an electro-optic modulator). A passively or actively Q-switched DPSS laser may produce output optical pulses that form an output light beam 125 of an integrated lidar and radar system 100.

In particular embodiments, an output beam of light 125 emitted by light source 110 may be a collimated optical beam having any suitable beam divergence, such as for example, a full-angle beam divergence of approximately 0.5 to 10 milliradians (mrad). A divergence of output light beam 125 may refer to an angular measure of an increase in beam size (e.g., a beam radius or beam diameter) as output light beam 125 travels away from light source 110 or integrated lidar and radar system 100. In particular embodiments, output light beam 125 may have a substantially circular cross section with a beam divergence characterized by a single divergence value. As an example, an output light beam 125 with a circular cross section and a full-angle beam divergence of 2 mrad may have a beam diameter or spot size of approximately 20 cm at a distance of 100 m from integrated lidar and radar system 100. In particular embodiments, output light beam 125 may have a substantially elliptical cross section characterized by two divergence values. As an example, output light beam 125 may have a fast axis and a slow axis, where the fast-axis divergence is greater than the slow-axis divergence. As another example, output light beam 125 may be an elliptical beam with a fast-axis divergence of 4 mrad and a slow-axis divergence of 2 mrad.

In particular embodiments, an output light beam 125 emitted by light source 110 may be unpolarized or randomly polarized, may have no specific or fixed polarization (e.g., the polarization may vary with time), or may have a particular polarization (e.g., output light beam 125 may be linearly polarized, elliptically polarized, or circularly polarized). As an example, light source 110 may produce light with no specific polarization or may produce light that is linearly polarized.

In particular embodiments, integrated lidar and radar system 100 may include one or more optical components configured to reflect, focus, filter, shape, modify, steer, or direct light within the integrated lidar and radar system 100 or light produced or received by the integrated lidar and radar system 100 (e.g., output light beam 125 or input light beam 135). As an example, integrated lidar and radar system 100 may include one or more lenses, mirrors, filters (e.g., bandpass or interference filters), beam splitters, optical splitters, polarizers, polarizing beam splitters, wave plates (e.g., half-wave or quarter-wave plates), diffractive elements, holographic elements, isolators, couplers, detectors, beam combiners, or collimators. The optical components in an integrated lidar and radar system 100 may be free-space optical components, fiber-coupled optical components, or a combination of free-space and fiber-coupled optical components.

In particular embodiments, integrated lidar and radar system 100 may include a telescope, one or more lenses, or one or more mirrors configured to expand, focus, or collimate the output light beam 125 or the input light beam 135 to a desired beam diameter or divergence. As an example, the integrated lidar and radar system 100 may include one or more lenses to focus the input light beam 135 onto a photodetector of light receiver 140. As another example, the integrated lidar and radar system 100 may include one or more flat mirrors or curved mirrors (e.g., concave, convex, or parabolic mirrors) to steer or focus the output light beam 125 or the input light beam 135. For example, the integrated lidar and radar system 100 may include an off-axis parabolic mirror to focus the input light beam 135 onto a photodetector of light receiver 140. As illustrated in FIG. 1B, the integrated lidar and radar system 100 may include mirror 115 (which may be a metallic or dielectric mirror), and mirror 115 may be configured so that output light beam 125 passes through the mirror 115 or passes along an edge or side of the mirror 115 and input light beam 135 is reflected toward the light receiver 140. As an example, mirror 115 (which may be referred to as an overlap mirror, superposition mirror, or beam-combiner mirror) may include a hole, slot, or aperture which output light beam 125 passes through. As another example, rather than passing through the mirror 115, the output light beam 125 may be directed to pass alongside the mirror 115 with a gap (e.g., a gap of width approximately 0.1 mm, 0.5 mm, 1 mm, 2 mm, 5 mm, or 10 mm) between the output light beam 125 and an edge of the mirror 115.

In particular embodiments, mirror 115 may provide for output light beam 125 and input light beam 135 to be substantially coaxial so that the two beams travel along approximately the same optical path (albeit in opposite directions). The input and output beams being substantially coaxial may refer to the beams being at least partially overlapped or sharing a common propagation axis so that input light beam 135 and output light beam 125 travel along substantially the same optical path (albeit in opposite directions). As an example, output light beam 125 and input light beam 135 may be parallel to each other to within less than 10 mrad, 5 mrad, 2 mrad, 1 mrad, 0.5 mrad, or 0.1 mrad. As output light beam 125 is scanned across a field of regard, the input light beam 135 may follow along with the output light beam 125 so that the coaxial relationship between the two beams is maintained.

In particular embodiments, integrated lidar and radar system 100 may include a dual mode scanner 120 configured to scan an output light beam 125 across a field of regard of the integrated lidar and radar system 100. As an example, dual mode scanner 120 may include one or more scanning mirrors configured to pivot, rotate, oscillate, or move in an angular manner about one or more rotation axes. The output light beam 125 may be reflected by a scanning mirror, and as the scanning mirror pivots or rotates, the reflected output light beam 125 may be scanned in a corresponding angular manner. As an example, a scanning mirror may be configured to periodically pivot back and forth over a 30-degree range, which results in the output light beam 125 scanning back and forth across a 60-degree range (e.g., a Θ-degree rotation by a scanning mirror results in a 2Θ-degree angular scan of output light beam 125).

In particular embodiments, a scanning mirror (which may be referred to as a scan mirror) may be attached to or mechanically driven by a scanner actuator or mechanism which pivots or rotates the mirror over a particular angular range (e.g., over a 5° angular range, 30° angular range, 60° angular range, 120° angular range, 360° angular range, or any other suitable angular range). A scanner actuator or mechanism configured to pivot or rotate a mirror may include a galvanometer scanner, a resonant scanner, a piezoelectric actuator, a voice coil motor, an electric motor (e.g., a DC motor, a brushless DC motor, a synchronous electric motor, or a stepper motor), a microelectromechanical systems (MEMS) device, or any other suitable actuator or mechanism. As an example, a dual mode scanner 120 may include a scanning mirror attached to a galvanometer scanner configured to pivot back and forth over a 1° to 30° angular range. As another example, a dual mode scanner 120 may include a scanning mirror that is attached to or is part of a MEMS device configured to scan over a 1° to 30° angular range. As another example, a dual mode scanner 120 may include a polygon mirror configured to rotate continuously in the same direction (e.g., rather than pivoting back and forth, the polygon mirror continuously rotates 360 degrees in a clockwise or counterclockwise direction). The polygon mirror may be coupled or attached to a synchronous motor configured to rotate the polygon mirror at a substantially fixed rotational frequency (e.g., a rotational frequency of approximately 1 Hz, 10 Hz, 50 Hz, 100 Hz, 500 Hz, or 1,000 Hz).

In particular embodiments, dual mode scanner 120 may be configured to scan the output light beam 125 (which may include at least a portion of the light emitted by light source 110) across a field of regard of the integrated lidar and radar system 100. A field of regard (FOR) of an integrated lidar and radar system 100 may refer to an area, region, or angular range over which the integrated lidar and radar system 100 may be configured to scan or capture distance information. As an example, an integrated lidar and radar system 100 with an output light beam 125 with a 30-degree scanning range may be referred to as having a 30-degree angular field of regard. As another example, an integrated lidar and radar system 100 with a scanning mirror that rotates over a 30-degree range may produce an output light beam 125 that scans across a 60-degree range (e.g., a 60-degree fOR). In particular embodiments, integrated lidar and radar system 100 may have a FOR of approximately 10°, 20°, 40°, 60°, 120°, 360°, or any other suitable FOR.

In particular embodiments, dual mode scanner 120 may be configured to scan the output light beam 125 horizontally and vertically, and integrated lidar and radar system 100 may have a particular FOR along the horizontal direction and another particular FOR along the vertical direction. As an example, integrated lidar and radar system 100 may have a horizontal FOR of 10° to 120° and a vertical FOR of 2° to 45°. In particular embodiments, dual mode scanner 120 may include a first scan mirror and a second scan mirror, where the first scan mirror directs the output light beam 125 toward the second scan mirror, and the second scan mirror directs the output light beam 125 downrange from the integrated lidar and radar system 100. As an example, the first scan mirror may scan the output light beam 125 along a first direction, and the second scan mirror may scan the output light beam 125 along a second direction that is different from the first direction (e.g., the second direction may be substantially orthogonal to the first direction). As another example, the first scan mirror may scan the output light beam 125 along a substantially horizontal direction, and the second scan mirror may scan the output light beam 125 along a substantially vertical direction (or vice versa). As another example, the first and second scan mirrors may each be driven by galvanometer scanners. As another example, the first or second scan mirror may include a polygon mirror driven by an electric motor. In particular embodiments, dual mode scanner 120 may be referred to as a beam scanner, optical scanner, or laser scanner.

In particular embodiments, one or more scanning mirrors may be communicatively coupled to controller 150 which may control the scanning mirror(s) so as to guide the output light beam 125 in a desired direction downrange or along a desired scan pattern. In particular embodiments, a scan pattern may refer to a pattern or path along which the output light beam 125 is directed. As an example, dual mode scanner 120 may include two scanning mirrors configured to scan the output light beam 125 across a 60° horizontal FOR and a 20° vertical FOR. The two scanner mirrors may be controlled to follow a scan path that substantially covers the 60°×20° FOR. As an example, the scan path may result in a point cloud with pixels that substantially cover the 60°×20° FOR. The pixels may be approximately evenly distributed across the 60°×20° FOR. Alternatively, the pixels may have a particular nonuniform distribution (e.g., the pixels may be distributed across all or a portion of the 60°×20° FOR, and the pixels may have a higher density in one or more particular regions of the 60°×20° FOR).

In particular embodiments, an integrated lidar and radar system 100 may include a dual mode scanner 120 with a solid-state scanning device. A solid-state scanning device may refer to a dual mode scanner 120 that scans an output light beam 125 without the use of moving parts (e.g., without the use of a mechanical scanner, such as a mirror that rotates or pivots). For example, a solid-state dual mode scanner 120 may include one or more of the following: an optical phased array scanning device; a liquid-crystal scanning device; or a liquid lens scanning device. A solid-state dual mode scanner 120 may be an electrically addressable device that scans an output light beam 125 along one axis (e.g., horizontally) or along two axes (e.g., horizontally and vertically). In particular embodiments, a dual mode scanner 120 may include a solid-state scanner and a mechanical scanner. For example, a dual mode scanner 120 may include an optical phased array scanner configured to scan an output light beam 125 in one direction and a galvanometer scanner that scans the output light beam 125 in an orthogonal direction. The optical phased array scanner may scan the output beam relatively rapidly in a horizontal direction across the field of regard (e.g., at a scan rate of 50 to 1,000 scan lines per second), and the galvanometer may pivot a mirror at a rate of 1-30 Hz to scan the output light beam 125 vertically.

In particular embodiments, an integrated lidar and radar system 100 may include a light source 110 configured to emit pulses of light and a dual mode scanner 120 configured to scan at least a portion of the emitted pulses of light across a field of regard of the integrated lidar and radar system 100. One or more of the emitted pulses of light may be scattered by a target 130 located downrange from the integrated lidar and radar system 100, and a light receiver 140 may detect at least a portion of the pulses of light scattered by the target 130. A light receiver 140 may be referred to as a photoreceiver, optical receiver, optical sensor, detector, photodetector, or optical detector. In particular embodiments, integrated lidar and radar system 100 may include a light receiver 140 that receives or detects at least a portion of input light beam 135 and produces an electrical signal that corresponds to input light beam 135. As an example, if input light beam 135 includes an optical pulse, then light receiver 140 may produce an electrical current or voltage pulse that corresponds to the optical pulse detected by light receiver 140. As another example, light receiver 140 may include one or more avalanche photodiodes (APDs) or one or more single-photon avalanche diodes (SPADs). As another example, light receiver 140 may include one or more PN photodiodes (e.g., a photodiode structure formed by a p-type semiconductor and an n-type semiconductor, where the PN acronym refers to the structure having p-doped and n-doped regions) or one or more PIN photodiodes (e.g., a photodiode structure formed by an undoped intrinsic semiconductor region located between p-type and n-type regions, where the PIN acronym refers to the structure having p-doped, intrinsic, and n-doped regions). An APD, SPAD, PN photodiode, or PIN photodiode may each be referred to as a detector, photodetector, or photodiode. A detector may have an active region or an avalanche-multiplication region that includes silicon, germanium, InGaAs, InAsSb (indium arsenide antimonide), AlAsSb (aluminum arsenide antimonide), or AlInAsSb (aluminum indium arsenide antimonide). The active region may refer to an area over which a detector may receive or detect input light. An active region may have any suitable size or diameter, such as for example, a diameter of approximately 10 μm, 25 μm, 50 μm, 80 μm, 100 μm, 200 μm, 500 μm, 1 mm, 2 mm, or 5 mm.

In particular embodiments, light receiver 140 may include electronic circuitry that performs signal amplification, sampling, filtering, signal conditioning, analog-to-digital conversion, time-to-digital conversion, pulse detection, threshold detection, rising-edge detection, or falling-edge detection. As an example, light receiver 140 may include a transimpedance amplifier that converts a received photocurrent (e.g., a current produced by an APD in response to a received optical signal) into a voltage signal. The voltage signal may be sent to signal-detection circuitry that produces an analog or digital output signal 145 that corresponds to one or more optical characteristics (e.g., rising edge, falling edge, amplitude, duration, or energy) of a received optical pulse. As an example, the signal-detection circuitry may perform a time-to-digital conversion to produce a digital output signal 145. The electrical output signal 145 may be sent to controller 150 for processing or analysis (e.g., to determine a time-of-flight value corresponding to a received optical pulse).

In particular embodiments, a controller 150 (which may include or may be referred to as a processor, an FPGA, an ASIC, a computer, or a computing system) may be located within an integrated lidar and radar system 100 or outside of an integrated lidar and radar system 100. Alternatively, one or more parts of a controller 150 may be located within an integrated lidar and radar system 100, and one or more other parts of a controller 150 may be located outside an integrated lidar and radar system 100. In particular embodiments, one or more parts of a controller 150 may be located within a light receiver 140 of an integrated lidar and radar system 100, and one or more other parts of a controller 150 may be located in other parts of the integrated lidar and radar system 100. For example, a light receiver 140 may include an FPGA or ASIC configured to process an output electrical signal from the light receiver 140, and the processed signal may be sent to a computing system located elsewhere within the integrated lidar and radar system 100 or outside the integrated lidar and radar system 100. In particular embodiments, a controller 150 may include any suitable arrangement or combination of logic circuitry, analog circuitry, or digital circuitry.

In particular embodiments, controller 150 may be electrically coupled or communicatively coupled to light source 110, dual mode scanner 120, or light receiver 140. As an example, controller 150 may receive electrical trigger pulses or edges from light source 110, where each pulse or edge corresponds to the emission of an optical pulse by light source 110. As another example, controller 150 may provide instructions, a control signal, or a trigger signal to light source 110 indicating when light source 110 should produce optical pulses. Controller 150 may send an electrical trigger signal that includes electrical pulses, where each electrical pulse results in the emission of an optical pulse by light source 110. In particular embodiments, the frequency, period, duration, pulse energy, peak power, average power, or wavelength of the optical pulses produced by light source 110 may be adjusted based on instructions, a control signal, or trigger pulses provided by controller 150. In particular embodiments, controller 150 may be coupled to light source 110 and light receiver 140, and controller 150 may determine a time-of-flight value for an optical pulse based on timing information associated with when the pulse was emitted by light source 110 and when a portion of the pulse (e.g., input light beam 135) was detected or received by light receiver 140. In particular embodiments, controller 150 may include circuitry that performs signal amplification, sampling, filtering, signal conditioning, analog-to-digital conversion, time-to-digital conversion, pulse detection, threshold detection, rising-edge detection, or falling-edge detection.

In particular embodiments, integrated lidar and radar system 100 may include one or more processors (e.g., a controller 150) configured to determine a distance D from the integrated lidar and radar system 100 to a target 130 based at least in part on a round-trip time of flight for an emitted pulse of light to travel from the integrated lidar and radar system 100 to the target 130 and back to the integrated lidar and radar system 100. The target 130 may be at least partially contained within a field of regard of the integrated lidar and radar system 100 and located a distance D from the integrated lidar and radar system 100 that is less than or equal to an operating range (R_{OP}) of the integrated lidar and radar system 100. In particular embodiments, an operating range (which may be referred to as an operating distance) of an integrated lidar and radar system 100 may refer to a distance over which the integrated lidar and radar system 100 is configured to sense or identify targets 130 located within a field of regard of the integrated lidar and radar system 100. The operating range of integrated lidar and radar system 100 may be any suitable distance, such as for example, 25 m, 50 m, 100 m, 200 m, 250 m, 500 m, or 1 km. As an example, an integrated lidar and radar system 100 with a 200-m operating range may be configured to sense or identify various targets 130 located up to 200 m away from the integrated lidar and radar system 100. The operating range R_{OP} of an integrated lidar and radar system 100 may be related to the time T between the emission of successive optical signals by the expression R_{OP}=c·τ/2. For an integrated lidar and radar system 100 with a 200-m operating range (R_{OP}=200 m), the time T between successive pulses (which may be referred to as a pulse period, a pulse repetition interval (PRI), or a time period between pulses) is approximately 2 R_{OP}/c≅1.33 μs. The pulse period T may also correspond to the time of flight for a pulse to travel to and from a target 130 located a distance R_{OP} from the integrated lidar and radar system 100. Additionally, the pulse period T may be related to the pulse repetition frequency (PRY) by the expression τ=1/PRF. For example, a pulse period of 1.33 μs corresponds to a PRF of approximately 752 kHz.

In particular embodiments, an integrated lidar and radar system 100 may be used to determine the distance to one or more downrange targets 130. By scanning the integrated lidar and radar system 100 across a field of regard, the system may be used to map the distance to a number of points within the field of regard. Each of these depth-mapped points may be referred to as a pixel or a voxel. A collection of pixels captured in succession (which may be referred to as a depth map, a point cloud, or a frame) may be rendered as an image or may be analyzed to identify or detect objects or to determine a shape or distance of objects within the FOR. As an example, a point cloud may cover a field of regard that extends 600 horizontally and 150 vertically, and the point cloud may include a frame of 100-2000 pixels in the horizontal direction by 4-400 pixels in the vertical direction.

In particular embodiments, integrated lidar and radar system 100 may be configured to repeatedly capture or generate point clouds of a field of regard at any suitable frame rate between approximately 0.1 frames per second (FPS) and approximately 1,000 FPS. As an example, integrated lidar and radar system 100 may generate point clouds at a frame rate of approximately 0.1 FPS, 0.5 FPS, 1 FPS, 2 FPS, 5 FPS, 10 FPS, 20 FPS, 100 FPS, 500 FPS, or 1,000 FPS. As another example, integrated lidar and radar system 100 may be configured to produce optical pulses at a rate of 5×10⁵ pulses/second (e.g., the system may determine 500,000 pixel distances per second) and scan a frame of 1000×50 pixels (e.g., 50,000 pixels/frame), which corresponds to a point-cloud frame rate of 10 frames per second (e.g., 10 point clouds per second). In particular embodiments, a point-cloud frame rate may be substantially fixed, or a point-cloud frame rate may be dynamically adjustable. As an example, an integrated lidar and radar system 100 may capture one or more point clouds at a particular frame rate (e.g., 1 Hz) and then switch to capture one or more point clouds at a different frame rate (e.g., 10 Hz). A slower frame rate (e.g., 1 Hz) may be used to capture one or more high-resolution point clouds, and a faster frame rate (e.g., 10 Hz) may be used to rapidly capture multiple lower-resolution point clouds.

In particular embodiments, an integrated lidar and radar system 100 may be configured to sense, identify, or determine distances to one or more targets 130 within a field of regard. As an example, an integrated lidar and radar system 100 may determine a distance to a target 130, where all or part of the target 130 is contained within a field of regard of the integrated lidar and radar system 100. All or part of a target 130 being contained within a FOR of the integrated lidar and radar system 100 may refer to the FOR overlapping, encompassing, or enclosing at least a portion of the target 130. In particular embodiments, target 130 may include all or part of an object that is moving or stationary relative to integrated lidar and radar system 100. As an example, target 130 may include all or a portion of a person, vehicle, motorcycle, truck, train, bicycle, wheelchair, pedestrian, animal, road sign, traffic light, lane marking, road-surface marking, parking space, pylon, guard rail, traffic barrier, pothole, railroad crossing, obstacle in or near a road, curb, stopped vehicle on or beside a road, utility pole, house, building, trash can, mailbox, tree, any other suitable object, or any suitable combination of all or part of two or more objects. In particular embodiments, a target may be referred to as an object.

In particular embodiments, light source 110, dual mode scanner 120, and light receiver 140 may be packaged together within a single housing, where a housing may refer to a box, case, or enclosure that holds or contains all or part of an integrated lidar and radar system 100. As an example, a lidar-system enclosure may contain a light source 110, mirror 115, dual mode scanner 120, and light receiver 140 of an integrated lidar and radar system 100. Additionally, the lidar-system enclosure may include a controller 150. The lidar-system enclosure may also include one or more electrical connections for conveying electrical power or electrical signals to or from the enclosure. In particular embodiments, one or more components of an integrated lidar and radar system 100 may be located remotely from a lidar-system enclosure. As an example, all or part of light source 110 may be located remotely from a lidar-system enclosure, and pulses of light produced by the light source 110 may be conveyed to the enclosure via optical fiber. As another example, all or part of a controller 150 may be located remotely from a lidar-system enclosure.

In particular embodiments, light source 110 may include an eye-safe laser, or integrated lidar and radar system 100 may be classified as an eye-safe laser system or laser product. An eye-safe laser, laser system, or laser product may refer to a system that includes a laser with an emission wavelength, average power, peak power, peak intensity, pulse energy, beam size, beam divergence, exposure time, or scanned output beam such that emitted light from the system presents little or no possibility of causing damage to a person's eyes. As an example, light source 110 or integrated lidar and radar system 100 may be classified as a Class 1 laser product (as specified by the 60825-1:2014 standard of the International Electrotechnical Commission (IEC)) or a Class I laser product (as specified by Title 21, Section 1040.10 of the United States Code of Federal Regulations (CFR)) that is safe under all conditions of normal use. In particular embodiments, integrated lidar and radar system 100 may be an eye-safe laser product (e.g., with a Class 1 or Class I classification) configured to operate at any suitable wavelength between approximately 900 nm and approximately 2100 nm. As an example, integrated lidar and radar system 100 may include a laser with an operating wavelength between approximately 1200 nm and approximately 1400 nm or between approximately 1400 nm and approximately 1600 nm, and the laser or the integrated lidar and radar system 100 may be operated in an eye-safe manner. As another example, integrated lidar and radar system 100 may be an eye-safe laser product that includes a scanned laser with an operating wavelength between approximately 900 nm and approximately 1700 nm. As another example, integrated lidar and radar system 100 may be a Class 1 or Class I laser product that includes a laser diode, fiber laser, or solid-state laser with an operating wavelength between approximately 1200 nm and approximately 1600 nm. As another example, integrated lidar and radar system 100 may have operating wavelengths between approximately 1500 nm and approximately 1550 nm.

In particular embodiments, one or more integrated lidar and radar systems 100 may be integrated into a vehicle. As an example, multiple integrated lidar and radar systems 100 may be integrated into a car to provide a complete 360-degree horizontal FOR around the car. As another example, 2-10 integrated lidar and radar systems 100, each system having a 45-degree to 180-degree horizontal FOR, may be combined together to form a sensing system that provides a point cloud covering a 360-degree horizontal FOR. The integrated lidar and radar systems 100 may be oriented so that adjacent FORs have an amount of spatial or angular overlap to allow data from the multiple integrated lidar and radar systems 100 to be combined or stitched together to form a single or continuous 360-degree point cloud. As an example, the FOR of each integrated lidar and radar system 100 may have approximately 1-30 degrees of overlap with an adjacent FOR. In particular embodiments, a vehicle may refer to a mobile machine configured to transport people or cargo. For example, a vehicle may include, may take the form of, or may be referred to as a car, automobile, motor vehicle, truck, bus, van, trailer, off-road vehicle, farm vehicle, lawn mower, construction equipment, forklift, robot, golf cart, motorhome, taxi, motorcycle, scooter, bicycle, skateboard, train, snowmobile, watercraft (e.g., a ship or boat), aircraft (e.g., a fixed-wing aircraft, helicopter, or dirigible), unmanned aerial vehicle (e.g., drone), or spacecraft. In particular embodiments, a vehicle may include an internal combustion engine or an electric motor that provides propulsion for the vehicle.

In particular embodiments, one or more integrated lidar and radar systems 100 may be included in a vehicle as part of an advanced driver assistance system (ADAS) to assist a driver of the vehicle in operating the vehicle. For example, an integrated lidar and radar system 100 may be part of an ADAS that provides information (e.g., about the surrounding environment) or feedback to a driver (e.g., to alert the driver to potential problems or hazards) or that automatically takes control of part of a vehicle (e.g., a braking system or a steering system) to avoid collisions or accidents. An integrated lidar and radar system 100 may be part of a vehicle ADAS that provides adaptive cruise control, automated braking, automated parking, collision avoidance, alerts the driver to hazards or other vehicles, maintains the vehicle in the correct lane, or provides a warning if an object or another vehicle is in a blind spot.

In particular embodiments, one or more integrated lidar and radar systems 100 may be integrated into a vehicle as part of an autonomous-vehicle driving system. As an example, an integrated lidar and radar system 100 may provide information about the surrounding environment to a driving system of an autonomous vehicle. An autonomous-vehicle driving system may be configured to guide the autonomous vehicle through an environment surrounding the vehicle and toward a destination. An autonomous-vehicle driving system may include one or more computing systems that receive information from an integrated lidar and radar system 100 about the surrounding environment, analyze the received information, and provide control signals to the vehicle's driving systems (e.g., steering mechanism, accelerator, brakes, lights, or turn signals). As an example, an integrated lidar and radar system 100 integrated into an autonomous vehicle may provide an autonomous-vehicle driving system with a point cloud every 0.1 seconds (e.g., the point cloud has a 10 Hz update rate, representing 10 frames per second). The autonomous-vehicle driving system may analyze the received point clouds to sense or identify targets 130 and their respective locations, distances, or speeds, and the autonomous-vehicle driving system may update control signals based on this information. As an example, if integrated lidar and radar system 100 detects a vehicle ahead that is slowing down or stopping, the autonomous-vehicle driving system may send instructions to release the accelerator and apply the brakes.

In particular embodiments, an autonomous vehicle may be referred to as an autonomous car, driverless car, self-driving car, robotic car, or unmanned vehicle. In particular embodiments, an autonomous vehicle may refer to a vehicle configured to sense its environment and navigate or drive with little or no human input. As an example, an autonomous vehicle may be configured to drive to any suitable location and control or perform all safety-critical functions (e.g., driving, steering, braking, parking) for the entire trip, with the driver not expected to control the vehicle at any time. As another example, an autonomous vehicle may allow a driver to safely turn their attention away from driving tasks in particular environments (e.g., on freeways), or an autonomous vehicle may provide control of a vehicle in all but a few environments, requiring little or no input or attention from the driver.

In particular embodiments, an autonomous vehicle may be configured to drive with a driver present in the vehicle, or an autonomous vehicle may be configured to operate the vehicle with no driver present. As an example, an autonomous vehicle may include a driver's seat with associated controls (e.g., steering wheel, accelerator pedal, and brake pedal), and the vehicle may be configured to drive with no one seated in the driver's seat or with little or no input from a person seated in the driver's seat. As another example, an autonomous vehicle may not include any driver's seat or associated driver's controls, and the vehicle may perform substantially all driving functions (e.g., driving, steering, braking, parking, and navigating) without human input. As another example, an autonomous vehicle may be configured to operate without a driver (e.g., the vehicle may be configured to transport human passengers or cargo without a driver present in the vehicle). As another example, an autonomous vehicle may be configured to operate without any human passengers (e.g., the vehicle may be configured for transportation of cargo without having any human passengers onboard the vehicle).

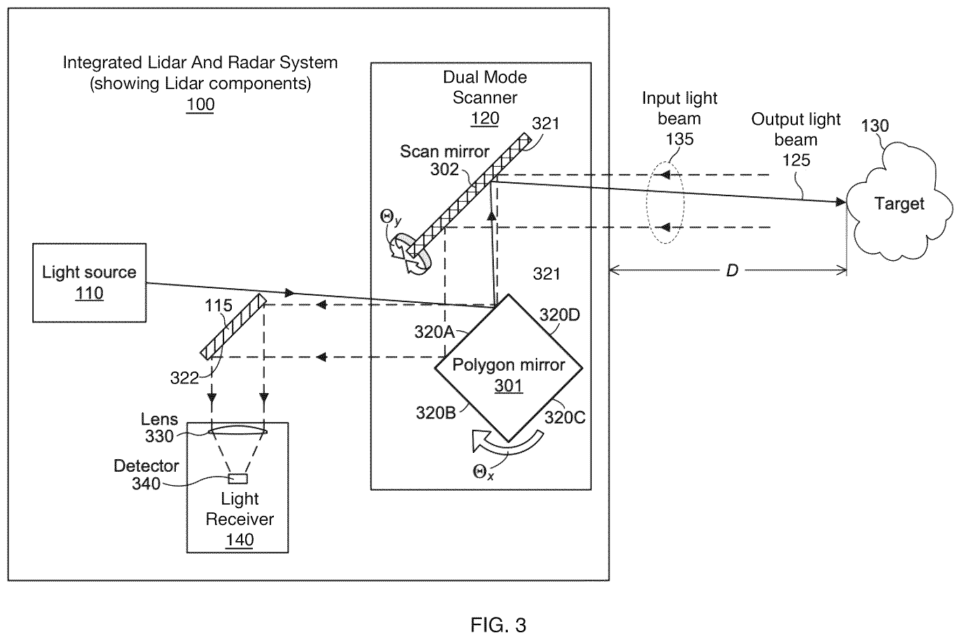

In particular embodiments, an optical signal (which may be referred to as a light signal, a light waveform, an optical waveform, an output beam, or emitted light) may include pulses of light, CW light, amplitude-modulated light, frequency-modulated (FM) light, or any suitable combination thereof. For example, an integrated lidar and radar system 100 as described or illustrated herein may be a pulsed lidar system and may include a light source 110 that produces pulses of light. The pulsed integrated lidar and radar system 100 may include a light source 110 that emits an output light beam 125 with optical pulses having one or more of the following optical characteristics: a wavelength between 900 nm and 2100 nm (e.g., a wavelength of approximately 905 nm, a wavelength between 1500 nm and 1510 nm, a wavelength between 1400 nm and 1600 nm, or any other suitable operating wavelength between 900 nm and 2100 nm); a pulse energy between 0.01 μJ and 100 μJ; a pulse repetition frequency between 80 kHz and 10 MHz; and a pulse duration between 1 ns and 100 ns. For example, the light source 110 in FIG. 1A or FIG. 3 may emit an output light beam 125 with optical pulses having a wavelength of approximately 1550 nm, a pulse energy of approximately 0.5 μJ, a pulse repetition frequency of approximately 600 kHz, and a pulse duration of approximately 5 ns. Although this disclosure describes or illustrates example embodiments of integrated lidar and radar systems 100 or light sources 110 that produce optical signals that include pulses of light, the embodiments described or illustrated herein may also be applied, where appropriate, to other types of optical signals, including continuous-wave (CW) light, amplitude-modulated optical signals, or frequency-modulated optical signals. For example, an integrated lidar and radar system 100 may be configured to operate as a frequency-modulated continuous-wave (FMCW) lidar system and may include a light source 110 that produces CW light or a frequency-modulated optical signal.

In particular embodiments, an integrated lidar and radar system 100 may be an FMCW lidar system where the emitted light from the light source 110 (e.g., output light beam 125 in FIG. 1A, FIG. 1B, or FIG. 3) includes frequency-modulated light. A pulsed lidar system is a type of integrated lidar and radar system 100 in which the light source 110 emits pulses of light, and the distance to a remote target 130 is determined based on the round-trip time-of-flight for a pulse of light to travel to the target 130 and back. Another type of integrated lidar and radar system 100 is a frequency-modulated lidar system, which may be referred to as a frequency-modulated continuous-wave (FMCW) lidar system. An FMCW lidar system uses frequency-modulated light to determine the distance to a remote target 130 based on a frequency of received light (which includes emitted light scattered by the remote target) relative to a frequency of local-oscillator (LO) light. A round-trip time for the emitted light to travel to a target 130 and back to the integrated lidar and radar system 100 may correspond to a frequency difference between the received scattered light and the LO light. A larger frequency difference may correspond to a longer round-trip time and a greater distance to the target 130.

A light source 110 for an FMCW lidar system may include at least one instance of (i) a direct-emitter laser diode, (ii) a seed laser diode followed by an SOA, (iii) a seed laser diode followed by a fiber-optic amplifier, or (iv) a seed laser diode followed by an SOA and then a fiber-optic amplifier. A seed laser diode or a direct-emitter laser diode may be operated in a CW manner (e.g., by driving the laser diode with a substantially constant DC current), and a frequency modulation may be provided by an external modulator (e.g., an electro-optic phase modulator may apply a frequency modulation to seed-laser light). Alternatively, a frequency modulation may be produced by applying a current modulation to a seed laser diode or a direct-emitter laser diode. The current modulation (which may be provided along with a DC bias current) may produce a corresponding refractive-index modulation in the laser diode, which results in a frequency modulation of the light emitted by the laser diode. The current-modulation component (and the corresponding frequency modulation) may have any suitable frequency or shape (e.g., piecewise linear, sinusoidal, triangle-wave, or sawtooth). For example, the current-modulation component (and the resulting frequency modulation of the emitted light) may increase or decrease monotonically over a particular time interval. As another example, the current-modulation component may include a triangle or sawtooth wave with an electrical current that increases or decreases linearly over a particular time interval, and the light emitted by the laser diode may include a corresponding frequency modulation in which the optical frequency increases or decreases approximately linearly over the particular time interval. For example, a light source 110 that emits light with a linear frequency change of 200 MHz over a 2-μs time interval may be referred to as having a frequency modulation m of 10¹⁴ Hz/s (or, 100 MHz/μs).

In addition to producing frequency-modulated emitted light, a light source 110 may also produce frequency-modulated local-oscillator (LO) light. The LO light may be coherent with the emitted light, and the frequency modulation of the LO light may match that of the emitted light. The LO light may be produced by splitting off a portion of the emitted light prior to the emitted light exiting the integrated lidar and radar system 100. Alternatively, the LO light may be produced by a seed laser diode or a direct-emitter laser diode that is part of the light source 110. For example, the LO light may be emitted from the back facet of a seed laser diode or a direct-emitter laser diode, or the LO light may be split off from the seed light emitted from the front facet of a seed laser diode. The received light (e.g., emitted light that is scattered by a target 130) and the LO light may each be frequency modulated, with a frequency difference or offset that corresponds to the distance to the target 130. For a linearly chirped light source (e.g., a frequency modulation that produces a linear change in frequency with time), the larger the frequency difference is between the received light and the LO light, the farther away the target 130 is located.

A frequency difference between received light and LO light may be determined by mixing the received light with the LO light (e.g., by coupling the two beams onto a detector 340 of a light receiver 140 so they are coherently mixed together at the detector) and determining the resulting beat frequency. For example, a photocurrent signal produced by an APD may include a beat signal resulting from the coherent mixing of the received light and the LO light, and a frequency of the beat signal may correspond to the frequency difference between the received light and the LO light. The photocurrent signal from an APD (or a voltage signal that corresponds to the photocurrent signal) may be analyzed using a frequency-analysis technique (e.g., a fast Fourier transform (FFT) technique) to determine the frequency of the beat signal. If a linear frequency modulation m (e.g., in units of Hz/s) is applied to a CW laser, then the round-trip time T may be related to the frequency difference Δf between the received scattered light and the LO light by the expression T=Δf/m. Additionally, the distance D from the target 130 to the integrated lidar and radar system 100 may be expressed as D=(Δf/m)·c/2, where c is the speed of light. For example, for a light source 110 with a linear frequency modulation of 10¹⁴ Hz/s, if a frequency difference (between the received scattered light and the LO light) of 33 MHz is measured, then this corresponds to a round-trip time of approximately 330 ns and a distance to the target of approximately 50 meters. As another example, a frequency difference of 133 MHz corresponds to a round-trip time of approximately 1.33 μs and a distance to the target of approximately 200 meters.

In particular embodiments, a receiver or processor of an FMCW lidar system may determine a frequency difference between received scattered light and LO light, and a distance to a target 130 may be determined based on the frequency difference. The frequency difference Δf between received scattered light and LO light corresponds to the round-trip time T (e.g., through the relationship T=Δf/m), and determining the frequency difference may correspond to or may be referred to as determining the round-trip time. For example, a receiver of a FMCW lidar system may determine a frequency difference between received scattered light and LO light, and based on the determined frequency difference, a processor may determine a distance to the target.

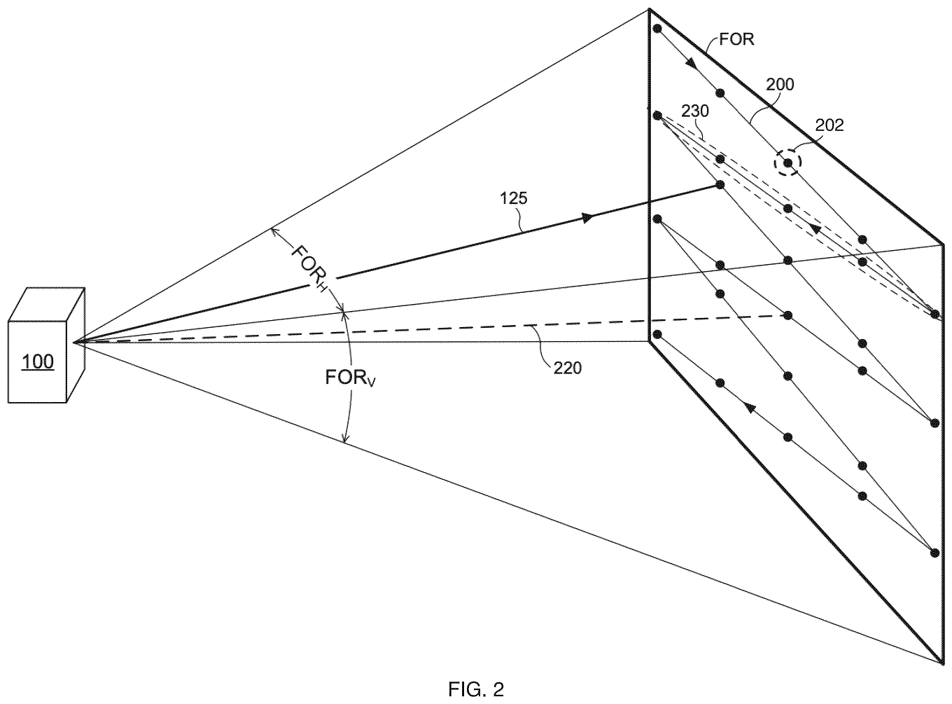

FIG. 2 illustrates an example scan pattern 200 produced by an integrated lidar and radar system 100. A dual mode scanner 120 of the integrated lidar and radar system 100 may scan the output light beam 125 (which may include multiple emitted optical signals) along a scan pattern 200 that is contained within a field of regard (FOR) of the integrated lidar and radar system 100. Although shown in FIG. 2 with respect to lidar scanning, a similar approach can be applied to scan RF signals using the corresponding radar components of integrated lidar and radar system 100. As illustrated for lidar, a scan pattern 200 (which may be referred to as an optical scan pattern, optical scan path, scan path, or scan) may represent a path or course followed by output light beam 125 as it is scanned across all or part of a FOR. Each traversal of a scan pattern 200 may correspond to the capture of a single frame or a single point cloud. In particular embodiments, an integrated lidar and radar system 100 may be configured to scan output light beam 125 along one or more particular scan patterns 200. In particular embodiments, a scan pattern 200 may scan across any suitable field of regard (FOR) having any suitable horizontal FOR (FOR_{H}) and any suitable vertical FOR (FOR_{V}). For example, a scan pattern 200 may have a field of regard represented by angular dimensions (e.g., FOR_{H}×FOR_{V}) 40°×30°, 90°×40°, or 60°×15°. As another example, a scan pattern 200 may have a FOR_{H} greater than or equal to 10°, 25°, 30°, 40°, 60°, 90°, or 120°. As another example, a scan pattern 200 may have a FOR_{V} greater than or equal to 2°, 5°, 10°, 15°, 20°, 30°, or 45°.

In the example of FIG. 2, reference line 220 represents a center of the field of regard of scan pattern 200. In particular embodiments, reference line 220 may have any suitable orientation, such as for example, a horizontal angle of 0° (e.g., reference line 220 may be oriented straight ahead) and a vertical angle of 0° (e.g., reference line 220 may have an inclination of 0°), or reference line 220 may have a nonzero horizontal angle or a nonzero inclination (e.g., a vertical angle of +10° or −10°). In FIG. 2, if the scan pattern 200 has a 60°×15° field of regard, then scan pattern 200 covers a ±30° horizontal range with respect to reference line 220 and a ±7.5° vertical range with respect to reference line 220. Additionally, output light beam 125 in FIG. 2 has an orientation of approximately −15° horizontal and +3° vertical with respect to reference line 220. Output light beam 125 may be referred to as having an azimuth of −15° and an altitude of +3° relative to reference line 220. In particular embodiments, an azimuth (which may be referred to as an azimuth angle) may represent a horizontal angle with respect to reference line 220, and an altitude (which may be referred to as an altitude angle, elevation, or elevation angle) may represent a vertical angle with respect to reference line 220.

In particular embodiments, a scan pattern 200 may include multiple pixels 202, and each pixel 202 may be associated with one or more laser pulses or one or more distance measurements. Additionally, a scan pattern 200 may include multiple scan lines 230, where each scan line represents one scan across at least part of a field of regard, and each scan line 230 may include multiple pixels 202. In FIG. 2, scan line 230 includes five pixels 202 and corresponds to an approximately horizontal scan across the FOR from right to left, as viewed from the integrated lidar and radar system 100. In particular embodiments, a cycle of scan pattern 200 may include a total of Pₓ×P_{y} pixels 202 (e.g., a two-dimensional distribution of Pₓ by P_{y} pixels). As an example, scan pattern 200 may include a distribution with dimensions of approximately 100-2,000 pixels 202 along a horizontal direction and approximately 4-400 pixels 202 along a vertical direction. As another example, scan pattern 200 may include a distribution of 1,000 pixels 202 along the horizontal direction by 64 pixels 202 along the vertical direction (e.g., the frame size is 1000×64 pixels) for a total of 64,000 pixels per cycle of scan pattern 200. In particular embodiments, the number of pixels 202 along a horizontal direction may be referred to as a horizontal resolution of scan pattern 200, and the number of pixels 202 along a vertical direction may be referred to as a vertical resolution. As an example, scan pattern 200 may have a horizontal resolution of greater than or equal to 100 pixels 202 and a vertical resolution of greater than or equal to 4 pixels 202. As another example, scan pattern 200 may have a horizontal resolution of 100-2,000 pixels 202 and a vertical resolution of 4-400 pixels 202.

In particular embodiments, each pixel 202 may be associated with a distance (e.g., a distance to a portion of a target 130 from which an associated laser pulse was scattered) or one or more angular values. As an example, a pixel 202 may be associated with a distance value and two angular values (e.g., an azimuth and altitude) that represent the angular location of the pixel 202 with respect to the integrated lidar and radar system 100. A distance to a portion of target 130 may be determined based at least in part on a time-of-flight measurement for a corresponding pulse. An angular value (e.g., an azimuth or altitude) may correspond to an angle (e.g., relative to reference line 220) of output light beam 125 (e.g., when a corresponding pulse is emitted from integrated lidar and radar system 100) or an angle of input light beam 135 (e.g., when an input signal is received by integrated lidar and radar system 100). In particular embodiments, an angular value may be determined based at least in part on a position of a component of dual mode scanner 120. As an example, an azimuth or altitude value associated with a pixel 202 may be determined from an angular position of one or more corresponding scanning mirrors of dual mode scanner 120.

FIG. 3 illustrates an example integrated lidar and radar system 100 with an example rotating polygon mirror 301. In the example shown, the embodiment of integrated lidar and radar system 100 of FIG. 3 shows primarily the lidar components of the integrated unit. The lidar components of the integrated lidar and radar system 100 are shown to describe the lidar functionality of the integrated lidar and radar system 100. In some embodiments, the integrated lidar and radar system 100 of FIG. 3 is the integrated lidar and radar system 100 of FIG. 1A. Although corresponding radar components of the integrated lidar and radar system 100 exist (as shown in FIG. 1A), they are not shown in FIG. 3.

In various embodiments, a dual mode scanner 120 may include a polygon mirror 301 configured to scan output light beam 125 along a particular direction. In the example of FIG. 3, dual mode scanner 120 includes two scanning mirrors: (1) a polygon mirror 301 that rotates along the Θₓ direction and (2) a scan mirror 302 that oscillates back and forth along the Θ_{y} direction. The output light beam 125 from light source 110, which passes alongside mirror 115, is reflected by reflecting surface 321 of scan mirror 302 and is then reflected by a reflecting surface (e.g., surface 320A, 320B, 320C, or 320D) of polygon mirror 301. Scattered light from a target 130 returns to the integrated lidar and radar system 100 as input light beam 135. The input light beam 135 reflects from polygon mirror 301, scan mirror 302, and mirror 115, which directs input light beam 135 through focusing lens 330 and to the detector 340 of light receiver 140. As shown in FIG. 3, scan mirror 302 includes reflecting surface 321 and mirror 115 includes reflecting surface 322. The detector 340 may be a PN photodiode, a PIN photodiode, an APD, an SPAD, or any other suitable detector. A reflecting surface 320 (which may be referred to as a reflective surface) may include a reflective metallic coating (e.g., gold, silver, or aluminum) or a reflective dielectric coating, and the reflecting surface 320 may have any suitable reflectivity R at an operating wavelength of the light source 110 (e.g., R greater than or equal to 70%, 80%, 90%, 95%, 98%, or 99%).

In particular embodiments, a polygon mirror 301 may be configured to rotate along a Θₓ or Θ_{y} direction and scan output light beam 125 along a substantially horizontal or vertical direction, respectively. A rotation along a Θₓ direction may refer to a rotational motion of mirror 301 that results in output light beam 125 scanning along a substantially horizontal direction. Similarly, a rotation along a Θ_{y} direction may refer to a rotational motion that results in output light beam 125 scanning along a substantially vertical direction. In FIG. 3, mirror 301 is a polygon mirror that rotates along the Θₓ direction and scans output light beam 125 along a substantially horizontal direction, and scan mirror 302 pivots along the Θ_{y} direction and scans output light beam 125 along a substantially vertical direction. In particular embodiments, a polygon mirror 301 may be configured to scan output light beam 125 along any suitable direction. As an example, a polygon mirror 301 may scan output light beam 125 at any suitable angle with respect to a horizontal or vertical direction, such as for example, at an angle of approximately 0°, 10°, 20°, 30°, 45°, 60°, 70°, 80°, or 90° with respect to a horizontal or vertical direction. Additionally, scan mirror 302 may scan the output light beam 125 along any suitable direction that is different from the scan direction of the polygon mirror 301. For example, scan mirror 302 may scan the output light beam 125 along a direction that is approximately orthogonal to the scan direction of the polygon mirror 301.

In particular embodiments, a polygon mirror 301 may refer to a multi-sided object having reflective surfaces 320 on two or more of its sides or faces. As an example, a polygon mirror may include any suitable number of reflective faces (e.g., 2, 3, 4, 5, 6, 7, 8, or 10 faces), where each face includes a reflective surface 320. A polygon mirror 301 may have a cross-sectional shape of any suitable polygon, such as for example, a triangle (with three reflecting surfaces 320), square (with four reflecting surfaces 320), pentagon (with five reflecting surfaces 320), hexagon (with six reflecting surfaces 320), heptagon (with seven reflecting surfaces 320), or octagon (with eight reflecting surfaces 320). In FIG. 3, the polygon mirror 301 has a substantially square cross-sectional shape and four reflecting surfaces (320A, 320B, 320C, and 320D). The polygon mirror 301 in FIG. 3 may be referred to as a square mirror, a cube mirror, or a four-sided polygon mirror. In FIG. 3, the polygon mirror 301 may have a shape similar to a cube, cuboid, or rectangular prism. Additionally, the polygon mirror 301 may have a total of six sides, where four of the sides include faces with reflective surfaces (320A, 320B, 320C, and 320D).

In particular embodiments, a polygon mirror 301 may be continuously rotated in a clockwise or counter-clockwise rotation direction about a rotation axis of the polygon mirror 301. The rotation axis may correspond to a line that is perpendicular to the plane of rotation of the polygon mirror 301 and that passes through the center of mass of the polygon mirror 301. In FIG. 3, the polygon mirror 301 rotates in the plane of the drawing, and the rotation axis of the polygon mirror 301 is perpendicular to the plane of the drawing. An electric motor may be configured to rotate a polygon mirror 301 at a substantially fixed frequency (e.g., a rotational frequency of approximately 1 Hz (or 1 revolution per second), 10 Hz, 50 Hz, 100 Hz, 500 Hz, or 1,000 Hz). As an example, a polygon mirror 301 may be mechanically coupled to an electric motor (e.g., a synchronous electric motor) which is configured to spin the polygon mirror 301 at a rotational speed of approximately 160 Hz (or, 9600 revolutions per minute (RPM)).

In particular embodiments, output light beam 125 may be reflected sequentially from the reflective surfaces 320A, 320B, 320C, and 320D as the polygon mirror 301 is rotated. This results in the output light beam 125 being scanned along a particular scan axis (e.g., a horizontal or vertical scan axis) to produce a sequence of scan lines, where each scan line corresponds to a reflection of the output light beam 125 from one of the reflective surfaces of the polygon mirror 301. In FIG. 3, the output light beam 125 reflects off of reflective surface 320A to produce one scan line. Then, as the polygon mirror 301 rotates, the output light beam 125 reflects off of reflective surfaces 320B, 320C, and 320D to produce a second, third, and fourth respective scan line. In particular embodiments, an integrated lidar and radar system 100 may be configured so that the output light beam 125 is first reflected from polygon mirror 301 and then from scan mirror 302 (or vice versa). As an example, an output light beam 125 from light source 110 may first be directed to polygon mirror 301, where it is reflected by a reflective surface of the polygon mirror 301, and then the output light beam 125 may be directed to scan mirror 302, where it is reflected by reflective surface 321 of the scan mirror 302. In the example of FIG. 3, the output light beam 125 is reflected from the polygon mirror 301 and the scan mirror 302 in the reverse order. In FIG. 3, the output light beam 125 from light source 110 is first directed to the scan mirror 302, where it is reflected by reflective surface 321, and then the output light beam 125 is directed to the polygon mirror 301, where it is reflected by reflective surface 320A.

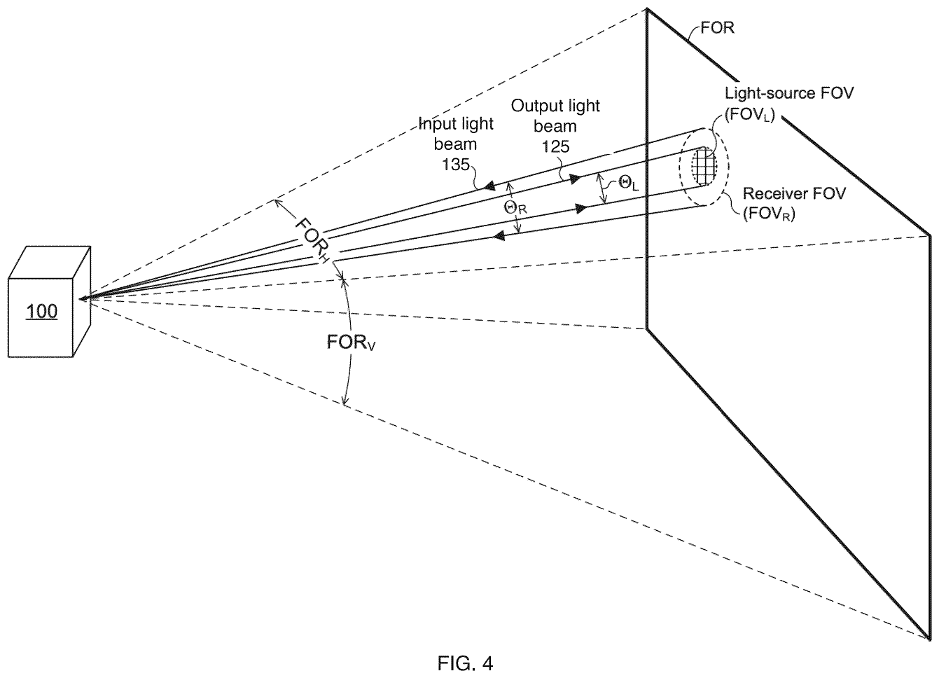

FIG. 4 illustrates an example light-source field of view (FOV_{L}) and receiver field of view (FOV_{R}) for an integrated lidar and radar system 100. Although shown in FIG. 4 with respect to a lidar field of view, a similar approach can be applied for the corresponding radar of integrated lidar and radar system 100. As illustrated for lidar, a light source 110 of integrated lidar and radar system 100 may emit pulses of light as the FOV_{L} and FOV_{R} are scanned by dual mode scanner 120 across a field of regard (FOR). In particular embodiments, a light-source field of view may refer to an angular cone illuminated by the light source 110 at a particular instant of time. Similarly, a receiver field of view may refer to an angular cone over which the light receiver 140 may receive or detect light at a particular instant of time, and any light outside the receiver field of view may not be received or detected. As an example, as the light-source field of view is scanned across a field of regard, a portion of a pulse of light emitted by the light source 110 may be sent downrange from integrated lidar and radar system 100, and the pulse of light may be sent in the direction that the FOV_{L} is pointing at the time the pulse is emitted. The pulse of light may scatter off a target 130, and the light receiver 140 may receive and detect a portion of the scattered light that is directed along or contained within the FOV_{R}.

In particular embodiments, dual mode scanner 120 may be configured to scan both a light-source field of view and a receiver field of view across a field of regard of the integrated lidar and radar system 100. Multiple pulses of light may be emitted and detected as the dual mode scanner 120 scans the FOV_{L} and FOV_{R} across the field of regard of the integrated lidar and radar system 100 while tracing out a scan pattern 200. In particular embodiments, the light-source field of view and the receiver field of view may be scanned synchronously with respect to one another, so that as the FOV_{L} is scanned across a scan pattern 200, the FOV_{R} follows substantially the same path at the same scanning speed. Additionally, the FOV_{L} and FOV_{R} may maintain the same relative position to one another as they are scanned across the field of regard. As an example, the FOV_{L} may be substantially overlapped with or centered inside the FOV_{R} (as illustrated in FIG. 4), and this relative positioning between FOV_{L} and FOV_{R} may be maintained throughout a scan. As another example, the FOV_{R} may lag behind the FOV_{L} by a particular, fixed amount throughout a scan (e.g., the FOV_{R} may be offset from the FOV_{L} in a direction opposite the scan direction).

In particular embodiments, the FOV_{L} may have an angular size or extent Θ_{L} that is substantially the same as or that corresponds to the divergence of the output light beam 125, and the FOV_{R} may have an angular size or extent ΘR that corresponds to an angle over which the light receiver 140 may receive and detect light. In particular embodiments, the receiver field of view may be any suitable size relative to the light-source field of view. As an example, the receiver field of view may be smaller than, substantially the same size as, or larger than the angular extent of the light-source field of view. In particular embodiments, the light-source field of view may have an angular extent of less than or equal to 50 milliradians, and the receiver field of view may have an angular extent of less than or equal to 50 milliradians. The FOV_{L} may have any suitable angular extent Θ_{L}, such as for example, approximately 0.1 mrad, 0.2 mrad, 0.5 mrad, 1 mrad, 1.5 mrad, 2 mrad, 3 mrad, 5 mrad, 10 mrad, 20 mrad, 40 mrad, or 50 mrad. Similarly, the FOV_{R} may have any suitable angular extent Θ_{R}, such as for example, approximately 0.1 mrad, 0.2 mrad, 0.5 mrad, 1 mrad, 1.5 mrad, 2 mrad, 3 mrad, 5 mrad, 10 mrad, 20 mrad, 40 mrad, or 50 mrad. In particular embodiments, the light-source field of view and the receiver field of view may have approximately equal angular extents. As an example, Θ_{L} and ΘR may both be approximately equal to 1 mrad, 2 mrad, or 4 mrad. In particular embodiments, the receiver field of view may be larger than the light-source field of view, or the light-source field of view may be larger than the receiver field of view. As an example, Θ_{L} may be approximately equal to 3 mrad, and Θ_{R} may be approximately equal to 4 mrad. As another example, Θ_{R} may be approximately K times larger than Θ_{L}, where K is any suitable factor, such as for example, 1.1, 1.2, 1.5, 2, 3, 5, or 10.

In particular embodiments, a pixel 202 may represent or may correspond to a light-source field of view or a receiver field of view. As the output light beam 125 propagates from the light source 110, the diameter of the output light beam 125 (as well as the size of the corresponding pixel 202) may increase according to the beam divergence Θ_{L}. As an example, if the output light beam 125 has a Θ_{L} of 2 mrad, then at a distance of 100 m from the integrated lidar and radar system 100, the output light beam 125 may have a size or diameter of approximately 20 cm, and a corresponding pixel 202 may also have a corresponding size or diameter of approximately 20 cm. At a distance of 200 m from the integrated lidar and radar system 100, the output light beam 125 and the corresponding pixel 202 may each have a diameter of approximately 40 cm.

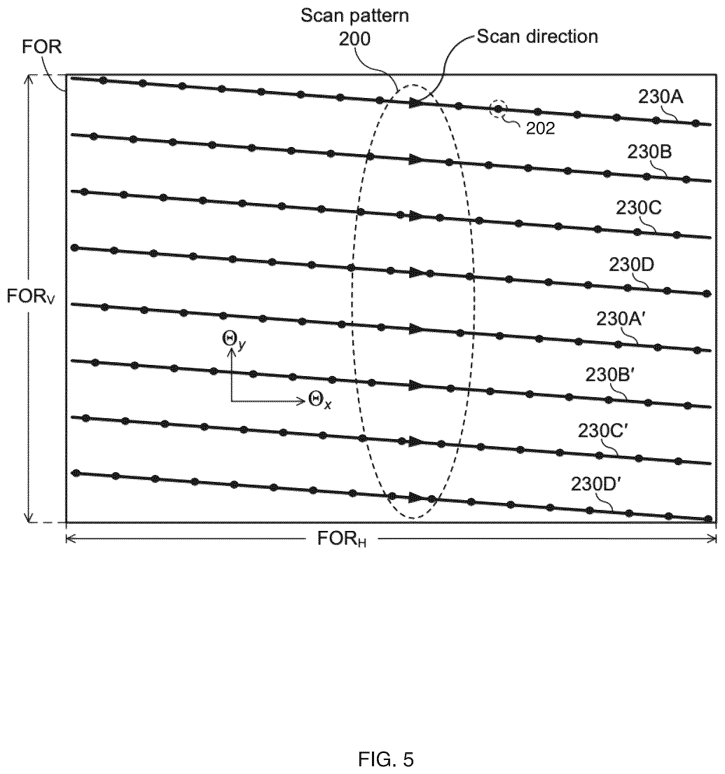

FIG. 5 illustrates an example unidirectional scan pattern 200 that includes multiple pixels 202 and multiple scan lines 230. In particular embodiments, scan pattern 200 may include any suitable number of scan lines 230 (e.g., approximately 1, 2, 5, 10, 20, 50, 100, 500, or 1,000 scan lines), and each scan line 230 of a scan pattern 200 may include any suitable number of pixels 202 (e.g., 1, 2, 5, 10, 20, 50, 100, 200, 500, 1,000, 2,000, or 5,000 pixels). The scan pattern 200 illustrated in FIG. 5 includes eight scan lines 230, and each scan line 230 includes approximately 16 pixels 202. In particular embodiments, a scan pattern 200 where the scan lines 230 are scanned in two directions (e.g., alternately scanning from right to left and then from left to right) may be referred to as a bidirectional scan pattern 200, and a scan pattern 200 where the scan lines 230 are scanned in the same direction may be referred to as a unidirectional scan pattern 200. The scan pattern 200 in FIG. 2 may be referred to as a bidirectional scan pattern, and the scan pattern 200 in FIG. 5 may be referred to as a unidirectional scan pattern 200 where each scan line 230 travels across the FOR in substantially the same direction (e.g., approximately from left to right as viewed from the integrated lidar and radar system 100). In particular embodiments, scan lines 230 of a unidirectional scan pattern 200 may be directed across a FOR in any suitable direction, such as for example, from left to right, from right to left, from top to bottom, from bottom to top, or at any suitable angle (e.g., at a 0°, 5°, 10°, 30°, or 45° angle) with respect to a horizontal or vertical axis. In particular embodiments, each scan line 230 in a unidirectional scan pattern 200 may be a separate line that is not directly connected to a previous or subsequent scan line 230.

In particular embodiments, a unidirectional scan pattern 200 may be produced by a dual mode scanner 120 that includes a polygon mirror (e.g., polygon mirror 301 of FIG. 3), where each scan line 230 is associated with a particular reflective surface 320 of the polygon mirror. As an example, reflective surface 320A of polygon mirror 301 in FIG. 3 may produce scan line 230A in FIG. 5. Similarly, as the polygon mirror 301 rotates, reflective surfaces 320B, 320C, and 320D may successively produce scan lines 230B, 230C, and 230D, respectively. Additionally, for a subsequent revolution of the polygon mirror 301, the scan lines 230A′, 230B′, 230C′, and 230D′ may be successively produced by reflections of the output light beam 125 or output radio frequency (RF) signal 225 from reflective surfaces 320A, 320B, 320C, and 320D, respectively. In particular embodiments, N successive scan lines 230 of a unidirectional scan pattern 200 may correspond to one full revolution of an N-sided polygon mirror. As an example, the four scan lines 230A, 230B, 230C, and 230D in FIG. 5 may correspond to one full revolution of the four-sided polygon mirror 301 in FIG. 3. Additionally, a subsequent revolution of the polygon mirror 301 may produce the next four scan lines 230A′, 230B′, 230C′, and 230D′ in FIG. 5.

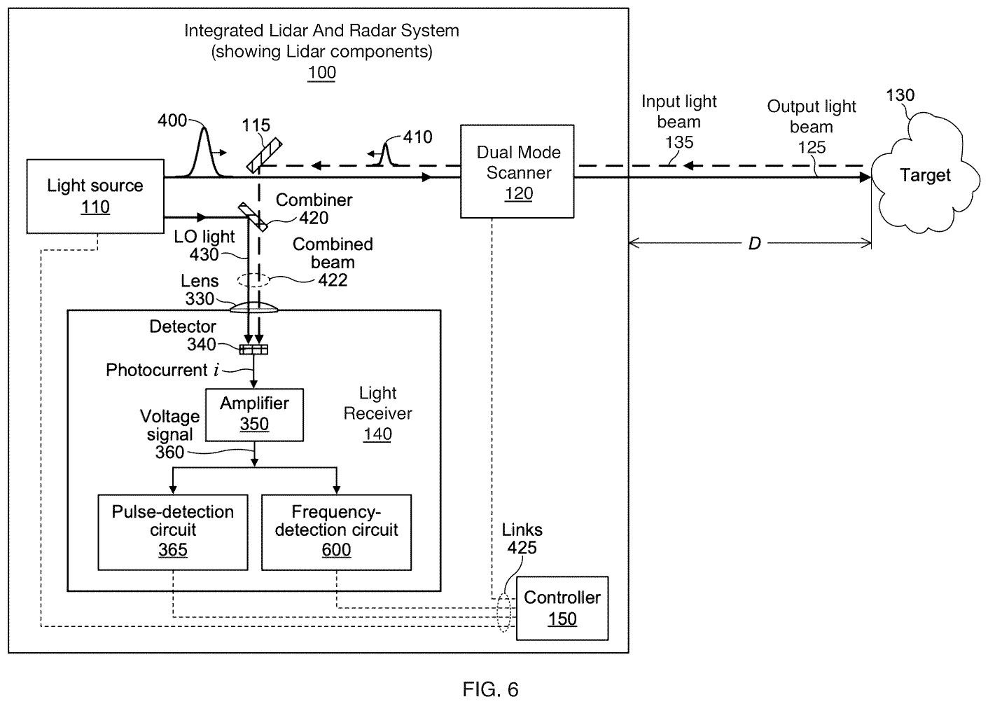

FIG. 6 illustrates an example integrated lidar and radar system 100 with a light source 110 that emits pulses of light 400 and local-oscillator (LO) light 430. In the example shown, the embodiment of integrated lidar and radar system 100 of FIG. 6 shows primarily the lidar components of the integrated unit including a light source 110, a dual mode scanner 120, a light receiver 140, and a controller 150. The lidar components of the integrated lidar and radar system 100 are shown to describe the lidar functionality of the integrated lidar and radar system 100. In some embodiments, the integrated lidar and radar system 100 of FIG. 6 is the integrated lidar and radar system 100 of FIG. 1A. Although corresponding radar components of the integrated lidar and radar system 100 exist (as shown in FIG. 1A), they are not shown in FIG. 6.

In various embodiments, the light receiver 140 includes a detector 340, an amplifier 350, a pulse-detection circuit 365, and a frequency-detection circuit 600. The integrated lidar and radar system 100 illustrated in FIG. 6 may be referred to as a coherent pulsed lidar system in which the light source 110 emits LO light 430 and pulses of light 400, where each emitted pulse of light 400 is coherent with a corresponding portion of the LO light 430. Additionally, the light receiver 140 in a coherent pulsed lidar system may be configured to detect the LO light 430 and a received pulse of light 410, where the LO light 430 and the received pulse of light 410 (which includes scattered light from one of the emitted pulses of light 400) are coherently mixed together at the light receiver 140. The LO light 430 may be referred to as a local-oscillator optical signal or a LO optical signal.

In particular embodiments, a coherent pulsed integrated lidar and radar system 100 may include a light source 110 configured to emit pulses of light 400 and LO light 430. The emitted pulses of light 400 may be part of an output light beam 125 that is scanned by a dual mode scanner 120 across a field of regard of the integrated lidar and radar system 100, and the LO light 430 may be sent to a light receiver 140 of the integrated lidar and radar system 100. The light source 110 may include a seed laser that produces seed light and the LO light 430. Additionally, the light source 110 may include an optical amplifier that amplifies the seed light to produce the emitted pulses of light 400. For example, the optical amplifier may be a pulsed optical amplifier that amplifies temporal portions of the seed light to produce the emitted pulses of light 400, where each amplified temporal portion of the seed light corresponds to one of the emitted pulses of light 400. The pulses of light 400 emitted by the light source 110 may have one or more of the following optical characteristics: a wavelength between 900 nm and 1700 nm; a pulse energy between 0.01 μJ and 100 μJ; a pulse repetition frequency between 80 kHz and 10 MHz; and a pulse duration between 0.1 ns and 20 ns. For example, the light source 110 may emit pulses of light 400 with a wavelength of approximately 1550 nm, a pulse energy of approximately 0.5 μJ, a pulse repetition frequency of approximately 750 kHz, and a pulse duration of approximately 5 ns. As another example, the light source 110 may emit pulses of light with a wavelength from approximately 1500 nm to approximately 1510 nm.

In particular embodiments, a coherent pulsed integrated lidar and radar system 100 may include a dual mode scanner 120 configured to scan an output light beam 125 across a field of regard of the integrated lidar and radar system 100. The dual mode scanner 120 may receive the output light beam 125 (which includes the emitted pulses of light 400) from the light source 110, and the dual mode scanner 120 may include one or more scanning mirrors configured to scan the output light beam 125. In addition to scanning the output light beam 125, the scanner may also scan a FOV of the detector 340 across the field of regard so that the output light beam 125 and the detector FOV are scanned synchronously at the same scanning speed or with the same relative position to one another. Alternatively, the integrated lidar and radar system 100 may be configured so that only the output light beam 125 is scanned, and the detector has a static FOV that is not scanned. In this case, the input light beam 135 (which includes received pulses of light 410) may bypass the dual mode scanner 120 and be directed to the light receiver 140 without passing through the dual mode scanner 120.

In particular embodiments, a coherent pulsed integrated lidar and radar system 100 may include an optical combiner 420 configured to optically combine LO light 430 with a received pulse of light 410. Optically combining LO light 430 with a received pulse of light 410 (which is part of the input beam 135) may include spatially overlapping the LO light 430 with the input light beam 135 to produce a combined beam 422. The combined beam 422 may include light from the LO light 430 and the input light beam 135 combined together so that the two beams propagate coaxially along the same path. For example, the combiner 420 in FIG. 6 may be a free-space optical beam-splitter that reflects at least part of the LO light 430 and transmits at least part of the input light beam 135 so that the LO light 430 and the input light beam 135 are spatially overlapped and propagate coaxially to the detector 340. As another example, the combiner 420 in FIG. 6 may be a mirror that reflects the LO light 430 and directs it to the detector 340, where it is combined with the input light beam 135. As another example, a combiner 420 may include an optical-waveguide component or a fiber-optic component that spatially overlaps the LO light 430 and the input light beam 135 so that the LO light 430 and the input light beam 135 propagate together in a waveguide or in a core of an optical fiber.

In particular embodiments, a coherent pulsed integrated lidar and radar system 100 may include a light receiver 140 that detects LO light 430 and received pulses of light 410. A received pulse of light 410 may include light from one of the emitted pulses of light 400 that is scattered by a target 130 located a distance from the integrated lidar and radar system 100. The light receiver 140 may include one or more detectors 340, and the LO light 430 and a received pulse of light 410 may be coherently mixed together at one or more of the detectors 340. One or more of the detectors 340 may produce photocurrent signals that correspond to the coherent mixing of the LO light 430 and the received pulse of light 410. The integrated lidar and radar system 100 in FIG. 6 includes a light receiver 140 with one detector 340 that receives the LO light 430 and the pulse of light 410, which are coherently mixed together at the detector 340. In response to the coherent mixing of the received LO light 430 and pulse of light 410, the detector 340 produces a photocurrent signal i that is amplified by an electronic amplifier 350.

In particular embodiments, a light receiver 140 may include a pulse-detection circuit 365 that determines a time-of-arrival for a received pulse of light 410. The time-of-arrival for a received pulse of light 410 may correspond to a time associated with a rising edge, falling edge, peak, or temporal center of the received pulse of light 410. The time-of-arrival may be determined based at least in part on a photocurrent signal i produced by a detector 340 of the light receiver 140. For example, a photocurrent signal i may include a pulse of current corresponding to the received pulse of light 410, and the electronic amplifier 350 may produce a voltage signal 360 with a voltage pulse that corresponds to the pulse of current. The pulse-detection circuit 365 may determine the time-of-arrival for the received pulse of light 410 based on a characteristic of the voltage pulse (e.g., based on a time associated with a rising edge, falling edge, peak, or temporal center of the voltage pulse). For example, the pulse-detection circuit 365 may receive an electronic trigger signal (e.g., from the light source 110 or the controller 150) when a pulse of light 400 is emitted, and the pulse-detection circuit 365 may determine the time-of-arrival for the received pulse of light 410 based on a time associated with an edge, peak, or temporal center of the voltage signal 360. The time-of-arrival may be determined based on a difference between a time when the pulse 400 is emitted and a time when the received pulse 410 is detected.

In particular embodiments, a coherent pulsed integrated lidar and radar system 100 may include a processor (e.g., controller 150) that determines the distance to a target 130 based at least in part on a time-of-arrival for a received pulse of light 410. The time-of-arrival for the received pulse of light 410 may correspond to a round-trip time (ΔT) for at least a portion of an emitted pulse of light 400 to travel to the target 130 and back to the integrated lidar and radar system 100, where the portion of the emitted pulse of light 400 that travels back to the target 130 corresponds to the received pulse of light 410. The distance D to the target 130 may be determined from the expression D=c·ΔT/2. For example, if the pulse-detection circuit 365 determines that the time AT between emission of optical pulse 400 and receipt of optical pulse 410 is 1 μs, then the controller 150 may determine that the distance to the target 130 is approximately 150 m. In particular embodiments, a round-trip time may be determined by a light receiver 140, by a controller 150, or by a light receiver 140 and controller 150 together. For example, a light receiver 140 may determine a round-trip time by subtracting a time when a pulse 400 is emitted from a time when a received pulse 410 is detected. As another example, a light receiver 140 may determine a time when a pulse 400 is emitted and a time when a received pulse 410 is detected. These values may be sent to a controller 150, and the controller 150 may determine a round-trip time by subtracting the time when the pulse 400 is emitted from the time when the received pulse 410 is detected.

In particular embodiments, a controller 150 of an integrated lidar and radar system 100 may be coupled to one or more components of the integrated lidar and radar system 100 via one or more data links 425. Each link 425 in FIG. 6 represents a data link that couples the controller 150 to another component of the integrated lidar and radar system 100 (e.g., light source 110, dual mode scanner 120, light receiver 140, pulse-detection circuit 365, or frequency-detection circuit 600). Although not shown in FIG. 6, controller 150 can be coupled to a radio frequency (RF) receiver as well, such as RF receiver 240 of FIG. 1A to correlate radar results with lidar results. Each data link 425 may include one or more electrical links, one or more wireless links, or one or more optical links, and the data links 425 may be used to send data, signals, or commands to or from the controller 150. For example, the controller 150 may send a command via a link 425 to the light source 110 instructing the light source 110 to emit a pulse of light 400. As another example, the pulse-detection circuit 365 may send a signal via a link 425 to the controller with information about a received pulse of light 410 (e.g., a time-of-arrival for the received pulse of light 410). Additionally, the controller 150 may be coupled via a link (not illustrated in FIG. 6) to a processor of an autonomous-vehicle driving system. The autonomous-vehicle processor may receive point-cloud data from the controller 150 and may make driving decisions based on the received point-cloud data.

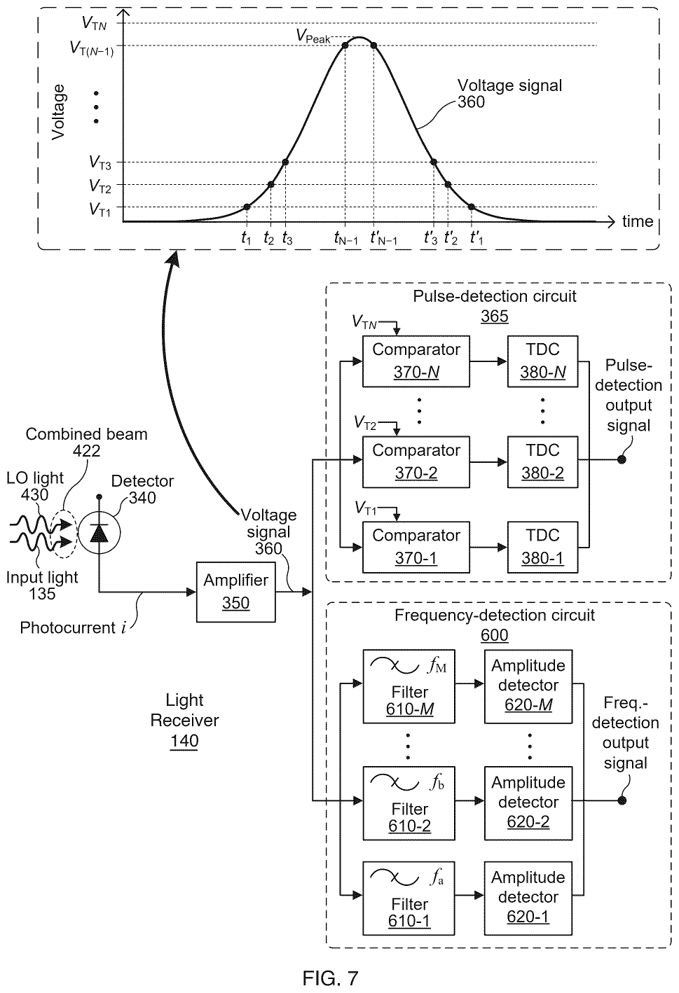

FIG. 7 illustrates an example light receiver 140 and an example voltage signal 360 corresponding to a received pulse of light 410. A light source 110 of an integrated lidar and radar system 100 may emit a pulse of light 400, and a light receiver 140 may be configured to detect a combined beam 422. The combined beam 422 in FIG. 7 includes LO light 430 and input light beam 135, where the input light beam 135 includes one or more received pulses of light 410. In particular embodiments, a light receiver 140 of an integrated lidar and radar system 100 may include one or more detectors 340, one or more amplifiers 350, one or more pulse-detection circuits 365, or one or more frequency-detection circuits 600. A pulse-detection circuit 365 may include one or more comparators 370 or one or more time-to-digital converters (TDCs) 380. A frequency-detection circuit 600 may include one or more electronic filters 610 or one or more electronic amplitude detectors 620.

The light receiver 140 illustrated in FIG. 7 includes a detector 340 configured to receive a combined beam 422 and produce a photocurrent i that corresponds to the coherent mixing of the LO light 430 and a received pulse of light 410 (which is part of the input light beam 135). The photocurrent i produced by the detector 340 may be referred to as a photocurrent signal or an electrical-current signal. The detector 340 may include an APD, PN photodiode, or PIN photodiode. For example, the detector 340 may include a silicon APD or PIN photodiode configured to detect light at an 800-1100 nm operating wavelength of an integrated lidar and radar system 100, or the detector 340 may include an InGaAs APD or PIN photodiode configured to detect light at a 1200-1600 nm operating wavelength. In FIG. 7, the detector 340 is coupled to an electronic amplifier 350 configured to receive the photocurrent i and produce a voltage signal 360 that corresponds to the received photocurrent. For example, the detector 340 may be an APD that produces a pulse of photocurrent in response to coherent mixing of LO light 430 and a received pulse of light 410, and the voltage signal 360 may be an analog voltage pulse that corresponds to the pulse of photocurrent. The amplifier 350 may include a transimpedance amplifier configured to receive the photocurrent i and amplify the photocurrent to produce a voltage signal that corresponds to the photocurrent signal. Additionally, the amplifier 350 may include a voltage amplifier that amplifies the voltage signal or an electronic filter (e.g., a low-pass or high-pass filter) that filters the photocurrent or the voltage signal.

In FIG. 7, the voltage signal 360 produced by the amplifier 350 is coupled to a pulse-detection circuit 365 and a frequency-detection circuit 600. The pulse-detection circuit includes N comparators (comparators 370-1, 370-2, . . . , 370-N), and each comparator is supplied with a particular threshold or reference voltage (V_{T1}, V_{T2}, . . . , V_{TN}). For example, light receiver 140 may include N=10 comparators, and the threshold voltages may be set to 10 values between 0 volts and 1 volt (e.g., V_{T1}=0.1 V, V_{T2}=0.2 V, and V_{T10}=1.0 V). A comparator may produce an electrical-edge signal (e.g., a rising or falling electrical edge) when the voltage signal 360 rises above or falls below a particular threshold voltage. For example, comparator 370-2 may produce a rising edge when the voltage signal 360 rises above the threshold voltage V_{T2}. Additionally or alternatively, comparator 370-2 may produce a falling edge when the voltage signal 360 falls below the threshold voltage V_{T2}.

The pulse-detection circuit 365 in FIG. 7 includes N time-to-digital converters (TDCs 380-1, 380-2, . . . , 380-N), and each comparator is coupled to one of the TDCs. Each comparator-TDC pair in FIG. 7 (e.g., comparator 370-1 and TDC 380-1) may be referred to as a threshold detector. A comparator may provide an electrical-edge signal to a corresponding TDC, and the TDC may act as a timer that produces an electrical output signal (e.g., a digital signal, a digital word, or a digital value) that represents a time when the edge signal is received from the comparator. For example, if the voltage signal 360 rises above the threshold voltage V_{T1}, then the comparator 370-1 may produce a rising-edge signal that is supplied to the input of TDC 380-1, and the TDC 380-1 may produce a digital time value corresponding to a time when the edge signal was received by TDC 380-1. The digital time value may be referenced to the time when a pulse of light is emitted, and the digital time value may correspond to or may be used to determine a round-trip time for the pulse of light to travel to a target 130 and back to the integrated lidar and radar system 100. Additionally, if the voltage signal 360 subsequently falls below the threshold voltage V_{T1}, then the comparator 370-1 may produce a falling-edge signal that is supplied to the input of TDC 380-1, and the TDC 380-1 may produce a digital time value corresponding to a time when the edge signal was received by TDC 380-1.

In particular embodiments, a pulse-detection output signal may be an electrical signal that corresponds to a received pulse of light 410. For example, the pulse-detection output signal in FIG. 7 may be a digital signal that corresponds to the analog voltage signal 360, which in turn corresponds to the photocurrent signal i, which in turn corresponds to a received pulse of light 410. If an input light beam 135 includes a received pulse of light 410, the pulse-detection circuit 365 may receive a voltage signal 360 (corresponding to the photocurrent i) and produce a pulse-detection output signal that corresponds to the received pulse of light 410. The pulse-detection output signal may include one or more digital time values from each of the TDCs 380 that received one or more edge signals from a comparator 370, and the digital time values may represent the analog voltage signal 360. The pulse-detection output signal may be sent to a controller 150, and a time-of-arrival for the received pulse of light 410 may be determined based at least in part on the one or more time values produced by the TDCs. For example, the time-of-arrival may be determined from a time associated with the peak (e.g., Vₚₑₐₖ) of the voltage signal 360 or from a temporal center of the voltage signal 360. Alternatively, the time-of-arrival may be determined from a time associated with a rising edge of the voltage signal 360. The pulse-detection output signal in FIG. 7 may correspond to the electrical output signal 145 in FIGS. 1A and/or 1B.

In particular embodiments, a pulse-detection output signal may include one or more digital values that correspond to a time interval between (1) a time when a pulse of light 400 is emitted and (2) a time when a received pulse of light 410 is detected by a light receiver 140. The pulse-detection output signal in FIG. 7 may include digital values from each of the TDCs that receive an edge signal from a comparator, and each digital value may represent a time interval between the emission of an optical pulse 400 by a light source 110 and the receipt of an edge signal from a comparator. For example, a light source 110 may emit a pulse of light 400 that is scattered by a target 130, and a light receiver 140 may receive a portion of the scattered pulse of light as an input pulse of light 410. When the light source emits the pulse of light 400, a count value of the TDCs may be reset to zero counts. Alternatively, the TDCs in light receiver 140 may accumulate counts continuously over two or more pulse periods (e.g., for 10, 100, 1,000, 10,000, or 100,000 pulse periods), and when a pulse of light 400 is emitted, the current TDC count may be stored in memory. After the pulse of light 400 is emitted, the TDCs may accumulate counts that correspond to elapsed time (e.g., the TDCs may count in terms of clock cycles or some fraction of clock cycles).

In FIG. 7, when TDC 380-1 receives an edge signal from comparator 370-1, the TDC 380-1 may produce a digital signal that represents the time interval between emission of the pulse of light 400 and receipt of the edge signal. For example, the digital signal may include a digital value that corresponds to the number of clock cycles that elapsed between emission of the pulse of light 400 and receipt of the edge signal. Alternatively, if the TDC 380-1 accumulates counts over multiple pulse periods, then the digital signal may include a digital value that corresponds to the TDC count at the time of receipt of the edge signal. The pulse-detection output signal may include digital values corresponding to one or more times when a pulse of light 400 was emitted and one or more times when a TDC received an edge signal. A pulse-detection output signal from a pulse-detection circuit 365 may correspond to a received pulse of light 410 and may include digital values from each of the TDCs that receive an edge signal from a comparator. The pulse-detection output signal may be sent to a controller 150, and the controller may determine the distance to the target 130 based at least in part on the pulse-detection output signal. Additionally or alternatively, the controller 150 may determine an optical characteristic of a received pulse of light 410 based at least in part on the pulse-detection output signal received from the TDCs of a pulse-detection circuit 365.

In particular embodiments, a light receiver 140 of an integrated lidar and radar system 100 may include one or more analog-to-digital converters (ADCs). As an example, instead of including multiple comparators and TDCs, a light receiver 140 may include an ADC that receives a voltage signal 360 from amplifier 350 and produces a digital representation of the voltage signal 360. Although this disclosure describes or illustrates example light receivers 140 that include one or more comparators 370 and one or more TDCs 380, a light receiver 140 may additionally or alternatively include one or more ADCs. As an example, in FIG. 7, instead of the N comparators 370 and N TDCs 380, the light receiver 140 may include an ADC configured to receive the voltage signal 360 and produce a digital output signal that includes digitized values that correspond to the voltage signal 360.

The example voltage signal 360 illustrated in FIG. 7 corresponds to a received pulse of light 410. The voltage signal 360 may be an analog signal produced by an electronic amplifier 350 and may correspond to a pulse of light detected by the light receiver 140 in FIG. 7. The voltage levels on the y-axis correspond to the threshold voltages V_{T1}, V_{T2}, . . . , V_{TN} of the respective comparators 370-1, 370-2, . . . , 370-N. The time values t₁, t₂, t₃, . . . , t_{N-1} correspond to times when the voltage signal 360 exceeds the corresponding threshold voltages, and the time values t′₁, t′₂, t′₃, . . . , t′_{N-1} correspond to times when the voltage signal 360 falls below the corresponding threshold voltages. For example, at time t₁ when the voltage signal 360 exceeds the threshold voltage V_{T1}, comparator 370-1 may produce an edge signal, and TDC 380-1 may output a digital value corresponding to the time t₁. Additionally, the TDC 380-1 may output a digital value corresponding to the time t′₁ when the voltage signal 360 falls below the threshold voltage V_{T1}. Alternatively, the light receiver 140 may include an additional TDC (not illustrated in FIG. 7) configured to produce a digital value corresponding to time t′₁ when the voltage signal 360 falls below the threshold voltage V_{T1}. The pulse-detection output signal from pulse-detection circuit 365 may include one or more digital values that correspond to one or more of the time values t₁, t₂, t₃, . . . , t_{N-1} and t′₁, t′₂, t′₃, . . . , t′_{N-1}. Additionally, the pulse-detection output signal may also include one or more values corresponding to the threshold voltages associated with the time values. Since the voltage signal 360 in FIG. 7 does not exceed the threshold voltage V_{TN}, the corresponding comparator 370-N may not produce an edge signal. As a result, TDC 380-N may not produce a time value, or TDC 380-N may produce a signal indicating that no edge signal was received.

In particular embodiments, a pulse-detection output signal produced by a pulse-detection circuit 365 of a light receiver 140 may correspond to or may be used to determine an optical characteristic of a received pulse of light 410 detected by the light receiver 140. An optical characteristic of a received pulse of light 410 may correspond to a peak optical intensity, a peak optical power, an average optical power, an optical energy, a shape or amplitude, a temporal duration, or a temporal center of the received pulse of light 410. For example, a pulse of light 410 detected by light receiver 140 may have one or more of the following optical characteristics: a peak optical power between 1 nanowatt and 10 watts; a pulse energy between 1 attojoule and 10 nanojoules; and a pulse duration between 0.1 ns and 50 ns. In particular embodiments, an optical characteristic of a received pulse of light 410 may be determined from a pulse-detection output signal provided by one or more TDCs 380 of a pulse-detection circuit 365 (e.g., as illustrated in FIG. 7), or an optical characteristic may be determined from a pulse-detection output signal provided by one or more ADCs of a pulse-detection circuit 365.

In particular embodiments, a peak optical power or peak optical intensity of a received pulse of light 410 may be determined from one or more values of a pulse-detection output signal provided by a light receiver 140. As an example, a controller 150 may determine the peak optical power of a received pulse of light 410 based on a peak voltage (Vₚₑₐₖ) of the voltage signal 360. The controller 150 may use a formula or lookup table that correlates a peak voltage of the voltage signal 360 with a value for the peak optical power. In the example of FIG. 7, the peak optical power of a pulse of light 410 may be determined from the threshold voltage V_{T(N-1)}, which is approximately equal to the peak voltage Vₚₑₐₖ of the voltage signal 360 (e.g., the threshold voltage V_{T(N-1)} may be associated with a pulse of light 410 having a peak optical power of 10 mW). As another example, a controller 150 may apply a curve-fit or interpolation operation to the values of a pulse-detection output signal to determine the peak voltage of the voltage signal 360, and this peak voltage may be used to determine the corresponding peak optical power of a received pulse of light 410.

In particular embodiments, an energy of a received pulse of light 410 may be determined from one or more values of a pulse-detection output signal. For example, a controller 150 may perform a summation of digital values that correspond to a voltage signal 360 to determine an area under the voltage-signal curve, and the area under the voltage-signal curve may be correlated with a pulse energy of a received pulse of light 410. As an example, the approximate area under the voltage-signal curve in FIG. 7 may be determined by subdividing the curve into M subsections (where M is approximately the number of time values included in the pulse-detection output signal) and adding up the areas of each of the subsections (e.g., using a numerical integration technique such as a Riemann sum, trapezoidal rule, or Simpson's rule). For example, the approximate area A under the voltage-signal curve 360 in FIG. 7 may be determined from a Riemann sum using the expression A=Σₖ₌₁^{M} V_{Tk}×Δtₖ, where V_{Tk} is a threshold voltage associated with the time value tₖ, and Δₜ_{ₖ} is a width of the subsection associated with time value tₖ. In the example of FIG. 7, the voltage signal 360 may correspond to a received pulse of light 410 with a pulse energy of 1 picojoule.

In particular embodiments, a duration of a received pulse of light 410 may be determined from a duration or width of a corresponding voltage signal 360. For example, the difference between two time values of a pulse-detection output signal may be used to determine a duration of a received pulse of light 410. In the example of FIG. 7, the duration of the pulse of light 410 corresponding to voltage signal 360 may be determined from the difference (t′₃−t₃), which may correspond to a received pulse of light 410 with a pulse duration of 4 nanoseconds. As another example, a controller 150 may apply a curve-fit or interpolation operation to the values of the pulse-detection output signal, and the duration of the pulse of light 410 may be determined based on the curve-fit or interpolation. One or more of the approaches for determining an optical characteristic of a received pulse of light 410 as described herein may be implemented using a light receiver 140 that includes multiple comparators 370 and TDCs 380 (as illustrated in FIG. 7) or using a light receiver 140 that includes one or more ADCs.

In FIG. 7, the voltage signal 360 produced by amplifier 350 is coupled to a frequency-detection circuit 600 as well as a pulse-detection circuit 365. The pulse-detection circuit 365 may provide a pulse-detection output signal that is used to determine time-domain information for a received pulse of light 410 (e.g., a time-of-arrival, duration, or energy of the received pulse of light 410), and the frequency-detection circuit 600 may provide frequency-domain information for the received pulse of light 410. For example, the frequency-detection output signal of the frequency-detection circuit 600 may include amplitude information for particular frequency components of the received pulse of light 410. The frequency-detection output signal may include the amplitude of one or more frequency components of a received pulse of light 410, and this amplitude information may be sent to a controller 150 for further processing. For example, the controller 150 may determine, based at least in part on the amplitude information, whether a received pulse of light is a valid received pulse of light 410 or an interfering pulse of light.

In particular embodiments, a frequency-detection circuit 600 may include multiple parallel frequency-measurement channels, and each frequency-measurement channel may include a filter 610 and a corresponding amplitude detector 620. In FIG. 7, the frequency-detection circuit 600 includes M electronic filters (filters 610-1, 610-2, . . . , 610-M), where each filter is associated with a particular frequency component (frequencies fₐ, f_{b}, . . . , f_{M}). Each filter 610 in FIG. 7 may include an electronic band-pass filter having a particular pass-band center frequency and width. For example, filter 610-2 may be a band-pass filter with a center frequency f_{b} of 1 GHz and a pass-band width of 20 MHz. Each filter 610 may include a passive filter implemented with one or more passive electronic components (e.g., one or more resistors, inductors, or capacitors). Alternatively, each filter 610 may include an active filter that includes one or more active electronic components (e.g., one or more transistors or op-amps) along with one or more passive components.

In addition to the M electronic filters 610, the frequency-detection circuit 600 in FIG. 7 also includes M electronic amplitude detectors (amplitude detectors 620-1, 620-2, . . . 620-M). An amplitude detector 620 may be configured to provide an output signal that corresponds to an amplitude (e.g., a peak value, a size, or an energy) of an electrical signal received from a filter 610. For example, filter 610-M may receive voltage signal 360 and provide to amplitude detector 620-M the portion of the voltage signal 360 having a frequency component at or near the frequency f_{M}. The amplitude detector 620-M may produce a digital or analog output signal that corresponds to the amplitude, peak value, size, or energy of the signal associated with the frequency component f_{M}. Each amplitude detector 620 may include a sample-and-hold circuit, a peak-detector circuit, an integrator circuit, or an ADC. For example, amplitude detector 620-M may include a sample-and-hold circuit and an ADC. The sample-and-hold circuit may produce an analog voltage corresponding to the amplitude of a signal received from filter 610-M, and the ADC may produce a digital signal that represents the analog voltage.

A frequency-detection circuit 600 may include 1, 2, 4, 8, 10, 20, or any other suitable number of filters 610 and amplitude detectors 620, and each filter may have a center frequency between approximately 200 MHz and approximately 20 GHz. Additionally, each filter 610 may include a band-pass filter having a pass-band with a frequency width of approximately 1 MHz, 10 MHz, 20 MHz, 50 MHz, 100 MHz, 200 MHz, or any other suitable frequency width. For example, a frequency-detection circuit 600 may include four band-pass filters 610 with center frequencies of approximately 1.0 GHz, 1.1 GHz, 1.2 GHz, and 1.3 GHz, and each filter may have a pass-band with a frequency width of approximately 20 MHz. A 1.0-GHz filter with a 20-MHz pass-band may pass or transmit frequency components from approximately 0.99 GHz to approximately 1.01 GHz and may attenuate frequency components outside of that frequency range.

In particular embodiments, a light source 110 of an integrated lidar and radar system 100 may impart a particular spectral signature to an emitted pulse of light 400. A spectral signature (which may be referred to as a frequency signature, frequency tag, or frequency change) may correspond to the presence or absence of particular frequency components that are imparted to an emitted pulse of light 400. Additionally or alternatively, a spectral signature may include an amplitude modulation, frequency modulation, or frequency change applied to an emitted pulse of light 400. For example, a spectral signature may include an amplitude or frequency modulation at a particular frequency (e.g., 1 GHz) that is applied to an emitted pulse of light 400. As another example, a spectral signature may include an amplitude or frequency modulation at two or more particular frequencies (e.g., 1.6 GHz and 2.0 GHz) that is applied to an emitted pulse of light 400. A received pulse of light 410 may include the same spectral signature that was applied to an associated emitted pulse of light 400, and the photocurrent signal i (as well as the corresponding voltage signal 360) may include one or more frequency components that correspond to the spectral signature. A frequency-detection circuit 600 may determine, based on the voltage signal 360 (which corresponds to the photocurrent signal i), one or more amplitudes of the one or more frequency components. In the example of FIG. 7, the frequency-detection circuit 600 may include M band-pass filters 610 and M amplitude detectors 620. Each band-pass filter 610 may have a center frequency corresponding to one of the frequency components (from fₐ to f_{M}), and each amplitude detector 620 may produce a signal corresponding to the amplitude of one of the respective frequency components. The frequency-detection output signal produced by the frequency-detection circuit 600 may include M digital values corresponding to the amplitudes of the M frequency components.

In particular embodiments, a controller 150 may determine, based on the amplitudes of one or more frequency components associated with a received pulse of light 410, whether the received pulse of light 410 is associated with a particular emitted pulse of light 400. If one or more frequency components of a received pulse of light 410 match a spectral signature of a particular emitted pulse of light 400, then the controller 150 may determine that the received pulse of light 410 is associated with the particular emitted pulse of light 400 (e.g., the received pulse of light 410 includes scattered light from the emitted pulse of light 400). Otherwise, if the frequency components do not match, then the controller 150 may determine that the received pulse of light 410 is not associated with the particular emitted pulse of light 400. For example, the received pulse of light 410 may be associated with a different pulse of light 400 emitted by the light source 110 of the integrated lidar and radar system 100, or the received pulse of light 410 may be associated with an interfering optical signal emitted by a different light source external to the integrated lidar and radar system 100. As another example, a particular pulse of light 400 emitted by the light source 110 may include a spectral signature with an amplitude modulation at a particular frequency (e.g., 2 GHz), and a frequency-detection circuit 600 may include a filter 610 and amplitude detector 620 that determine the amplitude of a 2-GHz frequency component for a received pulse of light 410. If the amplitude of the 2-GHz frequency component is greater than a particular threshold value (or within a range of two particular threshold values), then the controller 150 may determine that the received pulse of light 410 is associated with and includes light from the particular emitted pulse of light 400. Otherwise, if the amplitude of the 2-GHz frequency component is less than the particular threshold value, then the controller 150 may determine that the received pulse of light 410 is not associated with and does not include light from the particular emitted pulse of light 400. Additionally or alternatively, if the amplitude of a different frequency component (e.g., a 1.8-GHz frequency component) that is not part of a particular spectral signature is greater than a particular threshold value, then the controller may determine that the received pulse of light 410 is not associated with the emitted pulse of light 400 having that particular spectral signature. In various embodiments, the controller 150 may determine that the received pulse of light 410 is associated with the particular emitted pulse of light 400 based at least in part on correlated radar measurements such as based on a synchronized radio frequency (RF) signal transmitted with the particular emitted pulse of light 400 and a corresponding received reflection of the transmitted RF signal.

In particular embodiments, the amplitudes of the one or more frequency components associated with a received pulse of light 410 may be scaled by a scaling factor. This scaling of the frequency-component amplitudes may be used to compensate for a decrease in the energy, power, or intensity of a received pulse of light 410 as a function of distance of the target 130 from the integrated lidar and radar system 100. A controller 150 may receive, from a frequency-detection circuit 600, digital values corresponding to the amplitudes of one or more frequency components of a received pulse of light 410. Prior to comparing the frequency-component values to threshold values to determine whether the received pulse of light 410 is valid, the frequency-component values may be divided by a scaling factor that corresponds to an optical characteristic of the received pulse of light 410 (e.g., the energy, peak power, or peak intensity of the received pulse of light 410). Alternatively, the frequency-component amplitudes may be multiplied by a scaling factor that corresponds to D or D², where D is a distance to the target 130 from which the corresponding emitted pulse of light was scattered.

In particular embodiments, a light source 110 may emit pulses of light 400 where each emitted pulse of light 400 has a particular spectral signature of one or more different spectral signatures. The spectral signatures may be used to determine whether a received pulse of light is a valid received pulse of light 410 that is associated with an emitted pulse of light 400. A valid received pulse of light 410 may refer to a received pulse of light 410 that includes scattered light from a pulse of light 400 that was emitted by the light source 110. For example, a light source 110 may emit pulses of light 400 that each include the same spectral signature. If a received pulse of light matches that same spectral signature, then the received pulse of light may be determined to be a valid received pulse of light 410 that is associated with an emitted pulse of light 400. As another example, a light source 110 may emit pulses of light 400 that each include one spectral signature of two or more different spectral signatures. If a received pulse of light matches one of the spectral signatures, then the received pulse of light may be determined to be a valid received pulse of light 410 that is associated with an emitted pulse of light 400.

In particular embodiments, a received pulse of light may be determined to match a particular spectral signature if the received pulse of light includes each of the one or more frequency components associated with the particular spectral signature. Additionally, a received pulse of light may be determined to match the particular spectral signature if the received pulse of light does not include any frequency components that are not associated with the particular spectral signature. Similarly, a received pulse of light may be determined to not match a spectral signature if (i) the received pulse of light does not include all of the one or more frequency components associated with the spectral signature or (ii) the received pulse of light includes one or more frequency components not associated with the spectral signature. Determining whether a received pulse of light 410 includes a particular frequency component may include determining the amplitude of the particular frequency component (e.g., based on a signal from an amplitude detector 620). If the amplitude of the particular frequency component is greater than a particular threshold value (or between a minimum threshold value and a maximum threshold value), then a controller 150 may determine that a received pulse of light 410 includes the particular frequency component. Additionally or alternatively, if the amplitude of the particular frequency component is less than the particular threshold value, then the controller 150 may determine that the received pulse of light 410 does not include the particular frequency component.

In particular embodiments, a light source 110 may emit pulses of light 400 where each emitted pulse of light 400 has a particular spectral signature of two or more different spectral signatures, and the spectral signatures may be used to associate a received pulse of light 410 with a particular emitted pulse of light 400. For example, a light source 110 may emit pulses of light 400 with spectral signatures that alternate (e.g., sequentially or in a pseudo-random manner) between two, three, four, or any other suitable number of different spectral signatures. One spectral signature may include an amplitude modulation at 1.5 GHz, and another spectral signature may include an amplitude modulation at 1.7 GHz. A frequency-detection circuit 600 may include two filters and amplitude detectors that determine the amplitudes of the frequency components at 1.5 GHz and 1.7 GHz. Based on the amplitudes of the 1.5-GHz and 1.7-GHz frequency components of a received pulse of light 410, the controller 150 may determine whether the received pulse of light 410 is associated with an emitted pulse of light 400 having a 1.5-GHz spectral signature or a 1.7-GHz spectral signature. If a light source 110 emits a first pulse with a 1.5-GHz modulation and a second pulse with a 1.7-GHz modulation, then a controller 150 may determine that a received pulse of light 410 with a 1.5-GHz frequency component is associated with the first emitted pulse. Emitting pulses of light 400 that have different spectral signatures may allow a frequency-detection circuit 600 and controller 150 to prevent problems with ambiguity as to which emitted pulse a received pulse is associated with. A received pulse of light 410 may be unambiguously associated with an emitted pulse of light 400 based on the frequency components of the received pulse of light 410 matching the spectral signature of the emitted pulse of light 400.

In particular embodiments, a light source 110 may emit pulses of light 400 where each emitted pulse of light 400 has a particular spectral signature of one or more different spectral signatures, and the spectral signatures may be used to determine whether a received pulse of light is a valid received pulse of light 410 or an interfering optical signal. An interfering optical signal may refer to an optical signal that is sent by a light source external to the integrated lidar and radar system 100. For example, another lidar system or integrated lidar and radar system may emit a pulse of light that is detected by the light receiver 140, and the received pulse of light may be determined to be an interfering optical signal since it does not match the spectral signatures of the emitted pulses of light 400 from the light source 110. A controller 150 may distinguish valid pulses from interfering pulses by comparing the frequency components for a received pulse of light with the expected frequency components associated with the spectral signatures imparted to emitted pulses of light 400. If the frequency components of a received pulse of light do not match any of the one or more different spectral signatures imparted to the emitted pulses of light 400, then the controller 150 may determine that the received pulse of light is invalid and is not associated with any of the emitted pulses of light 400. For example, the received pulse of light may be an interfering pulse of light sent from a light source external to the integrated lidar and radar system 100, and the interfering pulse of light may be discarded or ignored since it is not associated with any of the emitted pulses of light 400.

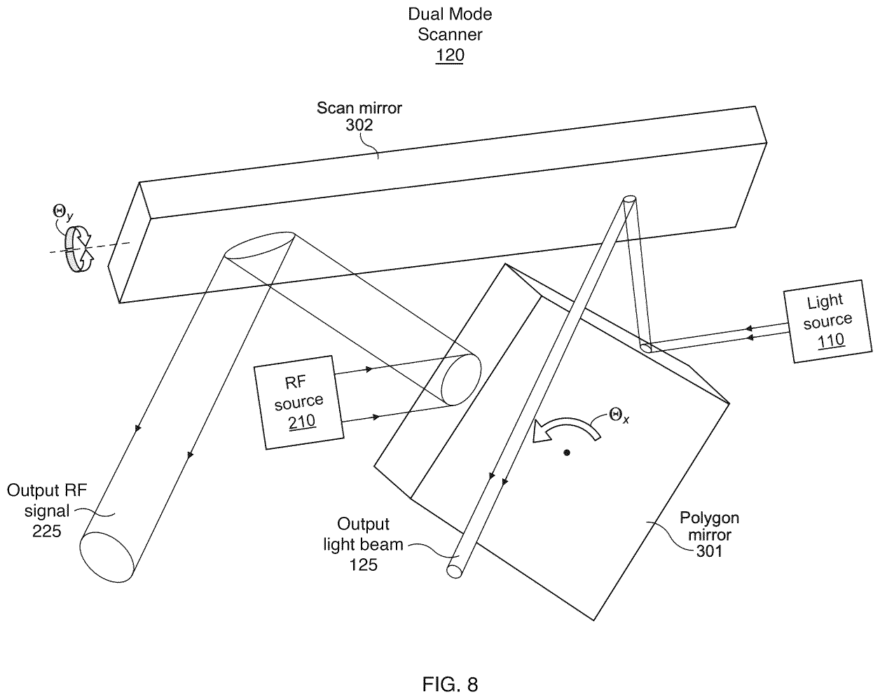

FIG. 8 illustrates an embodiment of a dual mode scanner of an integrated lidar and radar system. In the example shown, dual mode scanner 120 includes light source 110, radio frequency (RF) source 210, polygon mirror 301, and scan mirror 302. Dual mode scanner 120 scans light beams emitted by light source 110 and radio frequency (RF) signals transmitted by RF source 210. The light beams emitted from light source 110 are reflected off polygon mirror 301 and scan mirror 302. Similarly, the RF signals transmitted from RF source 210 are reflected off polygon mirror 301 and scan mirror 302. As shown in FIG. 8, polygon mirror 301 is configured to rotate along a Θₓ direction and scan mirror 302 is configured to rotate along a Oy direction. In some embodiments, dual mode scanner 120 is dual mode scanner 120 of FIGS. 1A, 1B, 3, and/or 6 and is used to synchronize the scanning of light pulses and RF signals.

The embodiment of dual mode scanner 120 illustrates a configuration where light source 110 and radio frequency (RF) source 210 are positioned such that their corresponding emitted light pulses and radio frequency (RF) signals reflect off different surfaces of polygon mirror 301. As shown FIG. 8, light source 110 and RF source 210 direct light pulses and RF signals, respectively, at different facets of polygon mirror 301. In particular embodiments, light pulses and RF signals are scanned using different facets of polygon mirror 301 to enable more space and/or separation for multiple radar channels. As illustrated, polygon mirror 301 is configured to rotate along a Θₓ direction and simultaneously scan output light beam 125 and output radio frequency (RF) signal 225 along a substantially horizontal direction at scan mirror 302. Scan mirror 302 is configured to rotate along a Θ_{y} direction and simultaneously scan output light beam 125 and output radio frequency (RF) signal 225 along a substantially vertical direction. In some embodiments, polygon mirror 301 is an azimuth mirror and scan mirror 302 is an elevation mirror. By utilizing both polygon mirror 301 and scan mirror 302, output light beam 125 and output RF signal 225 can be directed along both a Θₓ direction and a Θ_{y} direction to manipulate their azimuth and elevation, respectively and independently. In various embodiments, the Θₓ and Θ_{y} directions corresponding to polygon mirror 301 and scan mirror 302, respectively, are example directions and another coordinate system may be appropriate as well. In some embodiments, the Θₓ and Θ_{y} directions may be orthogonal or non-orthogonal to one another. Although utilizing different facets of polygon mirror 301, based on the placement and calibration of light source 110 and RF source 210 relative to polygon mirror 301, dual mode scanner 120 can be configured to scan the same region of interest for both light pulses and RF signals, directing output light beam 125 and output RF signal 225 along coordinated and/or synchronized paths.

In some embodiments, polygon mirror 301 and scan mirror 302 include materials that are reflective for both light and radio frequency (RF) signals. For example, polygon mirror 301 and scan mirror 302 may be one or more metals that can reflect both light and RF signals. In some embodiments, polygon mirror 301 and scan mirror 302 may each be coated, for example, with a protective layer such as gold. A protective layer allows polygon mirror 301 and scan mirror 302 to reflect both light and RF signals while also protecting the mirrors from effects such as oxidation.

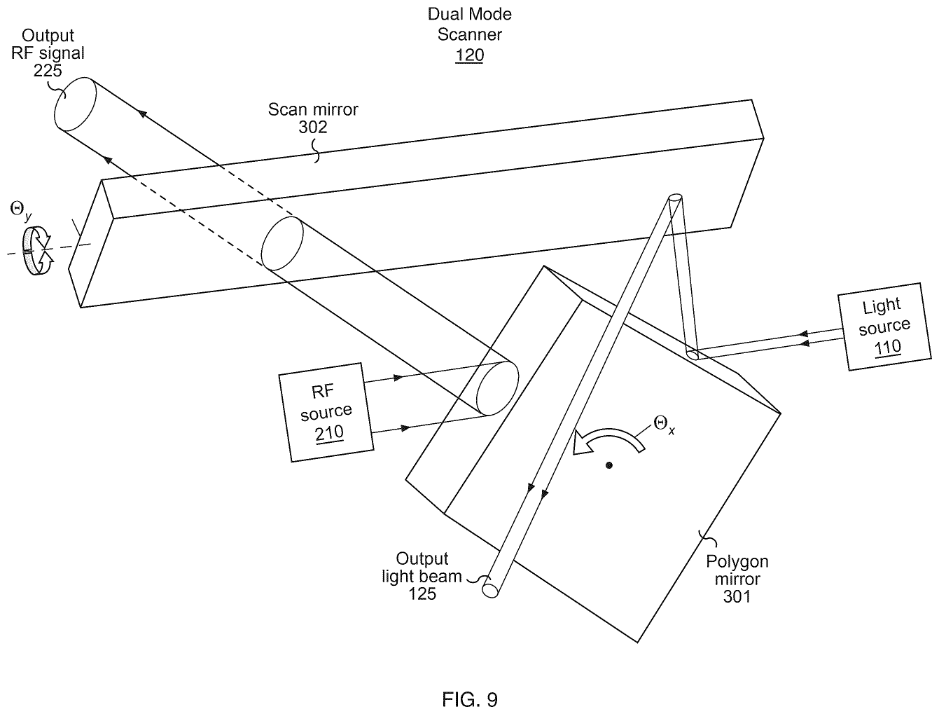

FIG. 9 illustrates an embodiment of a dual mode scanner of an integrated lidar and radar system. In the example shown, dual mode scanner 120 includes light source 110, radio frequency (RF) source 210, polygon mirror 301, and scan mirror 302. Dual mode scanner 120 scans light beams emitted by light source 110 and radio frequency (RF) signals transmitted by RF source 210. The light beams emitted from light source 110 are reflected off both polygon mirror 301 and scan mirror 302. As shown in FIG. 9, polygon mirror 301 is configured to rotate along a Θₓ direction and scan mirror 302 is configured to rotate along a Θ_{y} direction. Unlike dual mode scanner 120 of FIG. 8, dual mode scanner 120 of FIG. 9 includes an embodiment of scan mirror 302 that is reflective for light but transmissive for RF signals. The light pulses reflected off polygon mirror 301 and directed at scan mirror 302 are reflected off scan mirror 302 while the corresponding RF signals transmitted from RF source 210 are first reflected off polygon mirror 301 and directed at scan mirror 302 before passing through scan mirror 302. The emitted output light beam 125 and corresponding transmitted output radio frequency (RF) signal 225 are coupled along the Θₓ or azimuth direction but decoupled along the Θ_{y} or elevation direction. In some embodiments, dual mode scanner 120 is dual mode scanner 120 of FIGS. 1A, 1B, 3, and/or 6 and is used to synchronize the scanning of light pulses and RF signals along at least one axis.

The embodiment of dual mode scanner 120 in FIG. 9 illustrates a configuration where light source 110 and radio frequency (RF) source 210 are positioned to reflect their light pulses and radio frequency (RF) signals, respectively, off different surfaces of polygon mirror 301. As shown in FIG. 9, light source 110 and RF source 210 direct light pulses and RF signals, respectively, at different facets of polygon mirror 301. As illustrated, polygon mirror 301 is configured to rotate along a Θₓ direction and simultaneously scan output light beam 125 and output radio frequency (RF) signal 225 along a substantially horizontal direction at scan mirror 302. As a result, output light beam 125 and output RF signal 225 are synchronized along the Ox or azimuth direction. As illustrated, the embodiment of scan mirror 302 of FIG. 9 is configured to rotate along a Θ_{y} direction and simultaneously scan and reflect output light beam 125 along a substantially vertical direction while also transmitting output RF signal 225 without substantially modifying its vertical direction. In some embodiments, polygon mirror 301 is an azimuth mirror for both output light beam 125 and output RF signal 225 and scan mirror 302 is an elevation mirror for only output light beam 125. In some embodiments, the elevation of output RF signal 225 can be controlled through electronic steering. For example, RF source 210 can correspond to a phased array radar source (or another appropriate radar source) that can be electronically steered to control elevation scanning independent of output light beam 125 and scan mirror 302.

In particular embodiments, by utilizing polygon mirror 301 that is reflective for both light and radio frequency (RF) signals, output light beam 125 and output radio frequency (RF) signal 225 can be coordinated and synchronized along the Θₓ direction. With a material transmissive to RF signals, scan mirror 302 allows output light beam 125 to be decoupled from output RF signal 225 along the Θ_{y} direction. In various embodiments, the Θₓ and Θ_{y} directions corresponding to polygon mirror 301 and scan mirror 302, respectively, are example directions and another coordinate system may be appropriate as well. In some embodiments, the Θₓ and Oy directions may be orthogonal or non-orthogonal to one another. Although utilizing different facets of polygon mirror 301, based on the placement and calibration of light source 110 and RF source 210 relative to polygon mirror 301, dual mode scanner 120 can be configured to scan different and/or overlapping regions of interest for both light pulses and RF signals.

In some embodiments, polygon mirror 301 includes materials that are reflective for both light and radio frequency (RF) signals and scan mirror 302 utilizes materials that are reflective to light but transmissive to RF signals. For example, an optical coating of scan mirror 302 can allow for different scan functions by reflecting light pulses while sufficiently transmitting RF signals. In some embodiments, scan mirror 302 is a dichroic mirror that reflects light but is transmissive to radar wavelengths.

In various embodiments, the arrangement of the lidar and radar components including the two mirrors, polygon mirror 301 and scan mirror 302, as shown in FIG. 9 is an example configuration for a dual model scanner and other arrangements (not shown), including arrangements with one or more additional scan mirrors, lenses, focusing elements, collimators, beam combiners, beam splitters, etc. can be appropriate as well. For example, in some embodiments, dual mode scanner 120 includes a third scan mirror, such as an LATM mirror, that is reflective to both light and radio frequency (RF) signals. The use of the third scan mirror in certain configurations allows for the elevation of the lidar beam and radar signals to be synchronized and scanned mechanically. For example, a third scan mirror can function in coordination with scan mirror 302 to direct the elevation of light output beam 125 and output radio frequency (RF) signal 225. In particular embodiments, light output beam 125 can be reflected off polygon mirror 301 towards scan mirror 302 with a modified azimuth. Output light beam 125 is then reflected off scan mirror 302 and then a third scan mirror (not shown) that is arranged parallel to and above scan mirror 302. Scan mirror 302 and the third scan mirror control the elevation of output light beam 125. As an additional modification to dual mode scanner 120 of FIG. 9, radio frequency (RF) source 210 is located below scan mirror 302, which now functions as a lower turn mirror for output light beam 125 and is transmissive for output RF signal 225. When RF signals are directed from RF source 210 to scan mirror 302, the RF signals pass through scan mirror 302 and reflect off the third scan mirror, which mechanically controls the elevation of output RF signal 225. In some embodiments, RF source 210 is an array, a phased array, or another radar source.

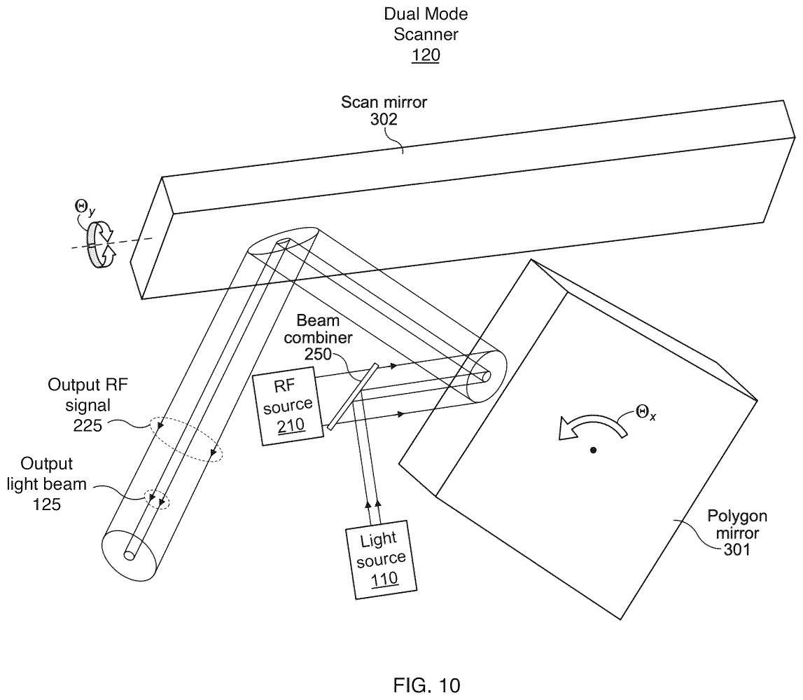

FIG. 10 illustrates an embodiment of a dual mode scanner of an integrated lidar and radar system. In the example shown, dual mode scanner 120 includes light source 110, radio frequency (RF) source 210, beam combiner 250, polygon mirror 301, and scan mirror 302. Dual mode scanner 120 scans light beams emitted by light source 110 and radio frequency (RF) signals transmitted by RF source 210. Beam combiner 250 allows the light beams emitted by light source 110 and RF signals transmitted by RF source 210 to be co-located as overlapping beams. The overlapping light and RF beams are both reflected off polygon mirror 301, using the same facet of polygon mirror 301, and then both reflected off scan mirror 302. In contrast to dual mode scanner 120 of FIG. 8, the embodiment of dual mode scanner 120 of FIG. 10 directs both the light beams emitted by light source 110 and RF signals transmitted by RF source 210 at the same surface of polygon mirror 301. The overlapping light and RF beams are scanned together as overlapping output light beam 125 and output radio frequency (RF) signal 225. The close proximity and overlapping nature of output light beam 125 and output RF signal 225 can improve the synchronization of lidar and radar measurements. As shown in FIG. 10, polygon mirror 301 is configured to rotate along a 92 direction and scan mirror 302 is configured to rotate along a Θ_{y} direction. In some embodiments, dual mode scanner 120 is dual mode scanner 120 of FIGS. 1A, 1B, 3, and/or 6 and is used to synchronize the scanning of light pulses and RF signals.

The embodiment of dual mode scanner 120 illustrates a configuration where light source 110 and radio frequency (RF) source 210 are positioned such that their corresponding emitted light pulses and radio frequency (RF) signals are combined using beam combiner 250 and both reflect off the same surface of polygon mirror 301. As illustrated, polygon mirror 301 is configured to rotate along a Θₓ direction and simultaneously scan output light beam 125 and output radio frequency (RF) signal 225 along a substantially horizontal direction at scan mirror 302. Scan mirror 302 is configured to rotate along a Θ_{y} direction and simultaneously scan output light beam 125 and output radio frequency (RF) signal 225 along a substantially vertical direction. In some embodiments, polygon mirror 301 is an azimuth mirror and scan mirror 302 is an elevation mirror. By utilizing both polygon mirror 301 and scan mirror 302, output light beam 125 and output RF signal 225 can be directed along both a Θₓ direction and a Θ_{y} direction to manipulate their azimuth and elevation, respectively and independently. In various embodiments, the Θₓ and Θ_{y} directions corresponding to polygon mirror 301 and scan mirror 302, respectively, are example directions and another coordinate system may be appropriate as well. In some embodiments, the Θₓ and Θ_{y} directions may be orthogonal or non-orthogonal to one another. By combining emitted output light beam 125 and transmitted output RF signal 225 together and utilizing the same facet of polygon mirror 301, dual mode scanner 120 can be configured to scan the same region of interest for both light pulses and RF signals, directing output light beam 125 and output RF signal 225 along coordinated and/or synchronized paths.

Although not shown in FIG. 10, alternative embodiments of dual mode scanner 120 that utilize a combined output light beam 125 and output radio frequency (RF) signal 225 are appropriate as well. For example, overlapping beams can be directed at the same polygon mirror 301 but utilize an embodiment of a scan mirror that is transmissive to radio frequency (RF) signals such as scan mirror 302 of FIG. 9 and alternative configurations described with respect to FIG. 9. In various embodiments, output light beam 125 and output RF signal 225 can be synchronized along the Θₓ or azimuth direction but are decoupled and can be independently scanned along the Θ_{y} or elevation direction.

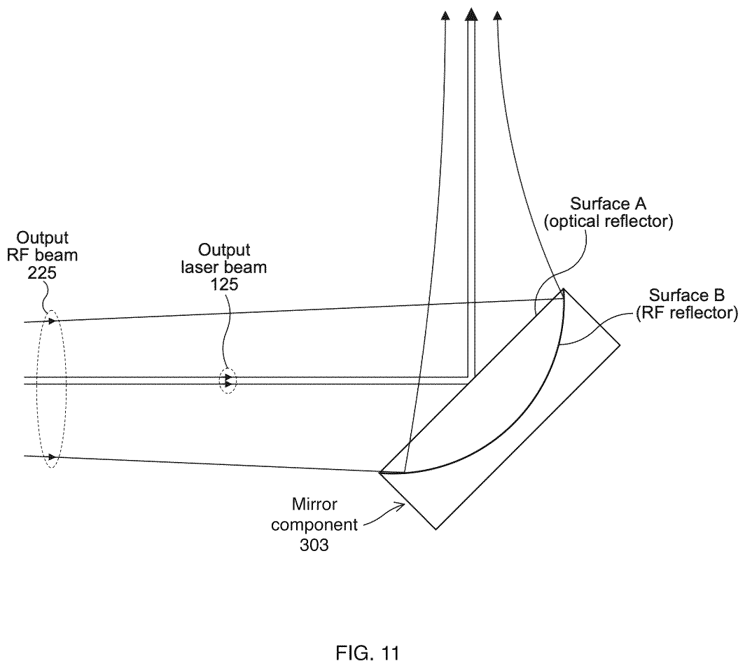

FIG. 11 illustrates an embodiment of a mirror component for a dual mode scanner of an integrated lidar and radar system. In the example shown, mirror component 303 is a component of a mirror such as a scan mirror of a dual mode scanner. Mirror component 303 includes surface A and surface B. Surface A of mirror component 303 is an optical reflector that is reflective to optical beams but transmissive to radio frequency (RF) signals. Surface B of mirror component 303 is a radio frequency (RF) reflector that is reflective to RF signals, reflecting RF signals that pass through surface A. In the example shown, output light beam 125 and output radio frequency (RF) signal 225 are directed at mirror component 303 but respond differently to surfaces A and B. As shown, output light beam 125 is reflected by surface A whereas output RF signal 225 is transmitted by surface A to surface B, where it is reflected and exits surface A. In the example shown, output light beam 125 and output RF signal 225 are reflected in the same general direction with different focus properties. The ability to modify output light beam 125 and output RF signal 225 independently allows each to be directed along the same or different path.

In some embodiments, mirror component 303 is a portion of a mirror of a dual mode scanner and one or more instances of mirror component 303 can be included in a single mirror. In some embodiments, one or more instances of mirror component 303 may be incorporated in any of the mirrors including polygon and scan mirrors of FIGS. 8-11. For example, a polygon mirror can contain multiple instances of mirror component 303, each with a flat optical facet whose optical reflective surface corresponds to surface A and whose underlying curved RF reflector surface corresponds to surface B. In some embodiments, the dual mode scanner of mirror component 303 is dual mode scanner 120 of FIGS. 1A, 1B, 3, 6, and/or 8-10.

In some embodiments, surface A of mirror component 303 is implemented as an optical coating that reflects optical beams but sufficiently transmits radar. Surface B can be implemented as a curved metallic surface. The different surfaces allow for focusing and/or modifying the corresponding reflected beam. For example, surface B can be shaped to focus and/or modify the divergence of a received radio frequency (RF) signal. In some embodiments, a radio frequency (RF) source component such as RF source 210 of FIGS. 1A and/or 8-10 can correspond to multiple different RF sources that are aimed at a common target such as a polygon facet. For example, an RF source component can contain multiple different RF transmission sources aligned in an arc and aimed at a polygon facet to provide multiple radar channels. The multiple channels can overscan the same field of view and/or be offset to scan different fields of view. In some embodiments, the RF sources can be multiplexed by polarization and then circularized when transmitted. In some embodiments, different polygons and their corresponding mirror components such as mirror component 303 can be stacked to enable different scan fields for radar and lidar.

In some embodiments, mirror component 303 is part of a dichroic mirror. For example, surface A of mirror component 303 can include a dichroic coating and the surface B can include a metallic coating. In some embodiments, mirror component 303 is constructed at least in part of a plastic or glass material. For example, the material between surfaces A and B can be a glass material or glass substrate with a dichroic coating for surface A and a metallic surface of a specific thickness for surface B. The material of surface B may be gold, aluminum, or another material reflective for radio frequency (RF) signals.

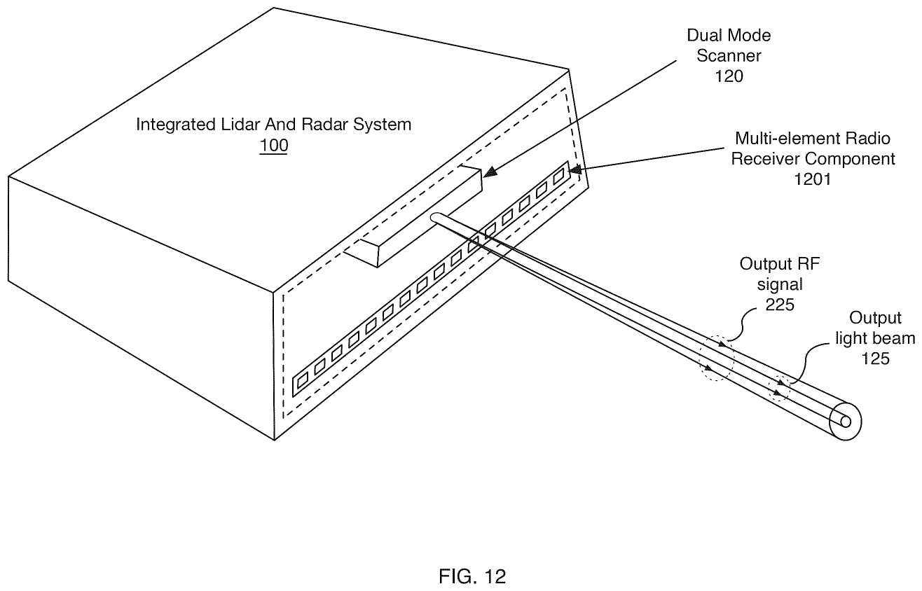

FIG. 12 illustrates an embodiment of an integrated light detection and ranging (lidar) and radio detection and ranging (radar) system. In the example shown, integrated lidar and radar system 100 utilizes a hybrid approach with multi-element radio receiver component 1201 physically located in a different location near the front of integrated lidar and radar system 100. In some embodiments, multi-element radio receiver component 1201 is separate and distinct from the body of the dual-mode transmission module. Alternatively, multi-element radio receiver component 1201 may be integrated with or attached to body of the dual-mode transmission module. In the example shown, multi-element radio receiver component 1201 is a multi-element phased array located out of the way from the transmit path of output light beam 125 and output RF signal 225. As shown in FIG. 12, output light beam 125 and output RF signal 225 are coupled and emitted from dual mode scanner 120 of integrated lidar and radar system 100. In some embodiments, multi-element radio receiver component 1201 is one of the components of an RF receiver such as an antenna component of RF receiver 240 of FIG. 1. In some embodiments, integrated lidar and radar system 100 is the integrated lidar and radar system described with respect to one or more of FIGS. 1A-1I and/or dual mode scanner 120 is the dual mode scanner described with respect to one or more of FIGS. 1A, 1B, 3, 6, and/or 8-11 that can be used to synchronize the scanning of light pulses and RF signals.

In some embodiments, integrated lidar and radar system 100 of FIG. 12 utilizes a hybrid approach for transmitting and receiving signals. For example, light pulses and RF signals are both emitted via dual mode scanner 120, and while light pulses are received and detected via dual mode scanner 120, RF signals are received at least at multi-element radio receiver component 1201. In various embodiments, multi-element radio receiver component 1201 is a multi-element array antenna such as a 16-element patch array antenna. The antenna can be configured as a two-dimensional patch antenna as well, such as with 2×8, 2×16, 4×4, or another patch antenna configuration. The specific design of multi-element radio receiver component 1201 can be flexible and can be customized to accommodate the available space and/or desired angular resolution. In various embodiments, multi-element radio receiver component 1201 can be internal, such as behind a glass barrier or window of integrated lidar and radar system 100, or external to integrated lidar and radar system 100, such as in front of the sensor system with an exterior radome (not shown). In some embodiments, partial mechanical scanning of RF signals can be performed as an alternative option. For example, an RF receiver can be configured to mechanically scan to receive RF signals along one or more axes, such as an axis associated with azimuth and/or an axis associated with elevation.

In various embodiments, with a hybrid approach, the transmitting and receiving of the RF signals can be performed from two (or more) different locations. For example, the transmitting of RF signals can be performed via a mirror assembly of integrated lidar and radar system 100 and mechanically scanned in sync with corresponding light pulses using dual mode scanner 120. However, the received RF signals can be received from one (or more) receiving antennas located at one or more different physical locations from dual mode scanner 120. In a hybrid approach, the transmission and receiving components for RF signals need not be co-located, allowing for customized applications and the use of multi-location antenna receivers.

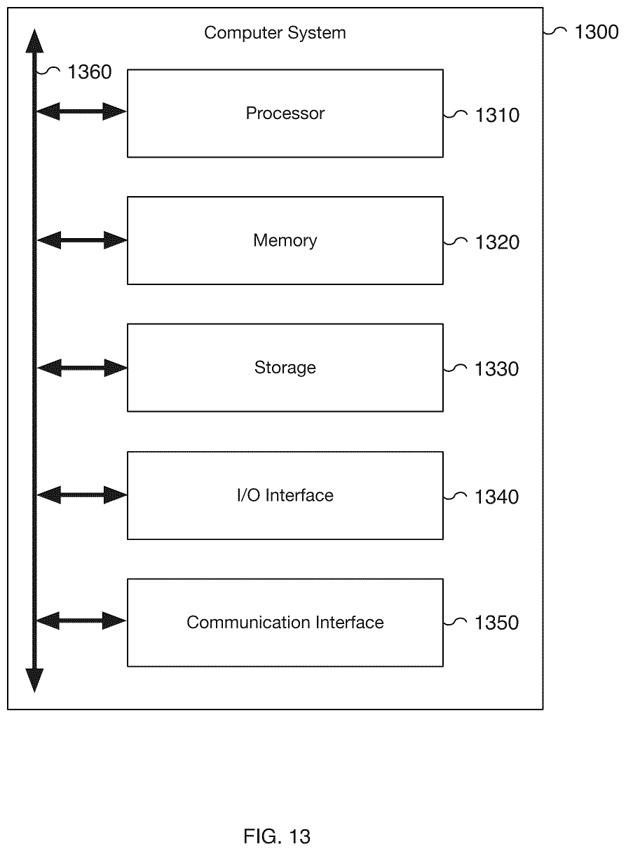

FIG. 13 illustrates an example computer system 1300. In particular embodiments, one or more computer systems 1300 may perform one or more steps of one or more methods described or illustrated herein. In particular embodiments, one or more computer systems 1300 may provide functionality described or illustrated herein. In particular embodiments, software running on one or more computer systems 1300 may perform one or more steps of one or more methods described or illustrated herein or may provide functionality described or illustrated herein. Particular embodiments may include one or more portions of one or more computer systems 1300. In particular embodiments, a computer system may be referred to as a processor, a controller, a computing device, a computing system, a computer, a general-purpose computer, or a data-processing apparatus. Herein, reference to a computer system may encompass one or more computer systems, where appropriate.

Computer system 1300 may take any suitable physical form. As an example, computer system 1300 may be an embedded computer system, a system-on-chip (SOC), a single-board computer system (SBC), a desktop computer system, a laptop or notebook computer system, a mainframe, a mesh of computer systems, a server, a tablet computer system, or any suitable combination of two or more of these. As another example, all or part of computer system 1300 may be combined with, coupled to, or integrated into a variety of devices, including, but not limited to, a camera, camcorder, personal digital assistant (PDA), mobile telephone, smartphone, electronic reading device (e.g., an e-reader), game console, smart watch, clock, calculator, television monitor, flat-panel display, computer monitor, vehicle display (e.g., odometer display or dashboard display), vehicle navigation system, lidar system, integrated lidar and radar system, ADAS, autonomous vehicle, autonomous-vehicle driving system, cockpit control, camera view display (e.g., display of a rear-view camera in a vehicle), eyewear, or head-mounted display. Where appropriate, computer system 1300 may include one or more computer systems 1300; be unitary or distributed; span multiple locations; span multiple machines; span multiple data centers; or reside in a cloud, which may include one or more cloud components in one or more networks. Where appropriate, one or more computer systems 1300 may perform without substantial spatial or temporal limitation one or more steps of one or more methods described or illustrated herein. As an example, one or more computer systems 1300 may perform in real time or in batch mode one or more steps of one or more methods described or illustrated herein. One or more computer systems 1300 may perform at different times or at different locations one or more steps of one or more methods described or illustrated herein, where appropriate.

As illustrated in the example of FIG. 13, computer system 1300 may include a processor 1310, memory 1320, storage 1330, an input/output (I/O) interface 1340, a communication interface 1350, or a bus 1360. Computer system 1300 may include any suitable number of any suitable components in any suitable arrangement.

In particular embodiments, processor 1310 may include hardware for executing instructions, such as those making up a computer program. As an example, to execute instructions, processor 1310 may retrieve (or fetch) the instructions from an internal register, an internal cache, memory 1320, or storage 1330; decode and execute them; and then write one or more results to an internal register, an internal cache, memory 1320, or storage 1330. In particular embodiments, processor 1310 may include one or more internal caches for data, instructions, or addresses. Processor 1310 may include any suitable number of any suitable internal caches, where appropriate. As an example, processor 1310 may include one or more instruction caches, one or more data caches, or one or more translation lookaside buffers (TLBs). Instructions in the instruction caches may be copies of instructions in memory 1320 or storage 1330, and the instruction caches may speed up retrieval of those instructions by processor 1310. Data in the data caches may be copies of data in memory 1320 or storage 1330 for instructions executing at processor 1310 to operate on; the results of previous instructions executed at processor 1310 for access by subsequent instructions executing at processor 1310 or for writing to memory 1320 or storage 1330; or other suitable data. The data caches may speed up read or write operations by processor 1310. The TLBs may speed up virtual-address translation for processor 1310. In particular embodiments, processor 1310 may include one or more internal registers for data, instructions, or addresses. Processor 1310 may include any suitable number of any suitable internal registers, where appropriate. Where appropriate, processor 1310 may include one or more arithmetic logic units (ALUs); may be a multi-core processor; or may include one or more processors 1310.

In particular embodiments, memory 1320 may include main memory for storing instructions for processor 1310 to execute or data for processor 1310 to operate on. As an example, computer system 1300 may load instructions from storage 1330 or another source (such as, for example, another computer system 1300) to memory 1320. Processor 1310 may then load the instructions from memory 1320 to an internal register or internal cache. To execute the instructions, processor 1310 may retrieve the instructions from the internal register or internal cache and decode them. During or after execution of the instructions, processor 1310 may write one or more results (which may be intermediate or final results) to the internal register or internal cache. Processor 1310 may then write one or more of those results to memory 1320. One or more memory buses (which may each include an address bus and a data bus) may couple processor 1310 to memory 1320. Bus 1360 may include one or more memory buses. In particular embodiments, one or more memory management units (MMUs) may reside between processor 1310 and memory 1320 and facilitate accesses to memory 1320 requested by processor 1310. In particular embodiments, memory 1320 may include random access memory (RAM). This RAM may be volatile memory, where appropriate. Where appropriate, this RAM may be dynamic RAM (DRAM) or static RAM (SRAM). Memory 1320 may include one or more memories 1320, where appropriate.

In particular embodiments, storage 1330 may include mass storage for data or instructions. As an example, storage 1330 may include a hard disk drive (HDD), a floppy disk drive, flash memory, an optical disc, a magneto-optical disc, magnetic tape, or a Universal Serial Bus (USB) drive or a combination of two or more of these. Storage 1330 may include removable or non-removable (or fixed) media, where appropriate. Storage 1330 may be internal or external to computer system 1300, where appropriate. In particular embodiments, storage 1330 may be non-volatile, solid-state memory. In particular embodiments, storage 1330 may include read-only memory (ROM). Where appropriate, this ROM may be mask ROM (MROM), programmable ROM (PROM), erasable PROM (EPROM), electrically erasable PROM (EEPROM), flash memory, or a combination of two or more of these. Storage 1330 may include one or more storage control units facilitating communication between processor 1310 and storage 1330, where appropriate. Where appropriate, storage 1330 may include one or more storages 1330.

In particular embodiments, I/O interface 1340 may include hardware, software, or both, providing one or more interfaces for communication between computer system 1300 and one or more I/O devices. Computer system 1300 may include one or more of these I/O devices, where appropriate. One or more of these I/O devices may enable communication between a person and computer system 1300. As an example, an I/O device may include a keyboard, keypad, microphone, monitor, mouse, printer, scanner, speaker, camera, stylus, tablet, touch screen, trackball, another suitable I/O device, or any suitable combination of two or more of these. An I/O device may include one or more sensors. Where appropriate, I/O interface 1340 may include one or more device or software drivers enabling processor 1310 to drive one or more of these I/O devices. I/O interface 1340 may include one or more I/O interfaces 1340, where appropriate.

In particular embodiments, communication interface 1350 may include hardware, software, or both providing one or more interfaces for communication (such as, for example, packet-based communication) between computer system 1300 and one or more other computer systems 1300 or one or more networks. As an example, communication interface 1350 may include a network interface controller (NIC) or network adapter for communicating with an Ethernet or other wire-based network or a wireless NIC (WNIC); a wireless adapter for communicating with a wireless network, such as a WI-FI network; or an optical transmitter (e.g., a laser or a light-emitting diode) or an optical receiver (e.g., a photodetector) for communicating using fiber-optic communication or free-space optical communication. Computer system 1300 may communicate with an ad hoc network, a personal area network (PAN), an in-vehicle network (IVN), a local area network (LAN), a wide area network (WAN), a metropolitan area network (MAN), or one or more portions of the Internet or a combination of two or more of these. One or more portions of one or more of these networks may be wired or wireless. As an example, computer system 1300 may communicate with a wireless PAN (WPAN) (such as, for example, a BLUETOOTH WPAN), a WI-FI network, a Worldwide Interoperability for Microwave Access (WiMAX) network, a cellular telephone network (such as, for example, a Global System for Mobile Communications (GSM) network), or other suitable wireless network or a combination of two or more of these. As another example, computer system 1300 may communicate using fiber-optic communication based on 100 Gigabit Ethernet (100 GbE), 10 Gigabit Ethernet (10 GbE), or Synchronous Optical Networking (SONET). Computer system 1300 may include any suitable communication interface 1350 for any of these networks, where appropriate. Communication interface 1350 may include one or more communication interfaces 1350, where appropriate.

In particular embodiments, bus 1360 may include hardware, software, or both coupling components of computer system 1300 to each other. As an example, bus 1360 may include an Accelerated Graphics Port (AGP) or other graphics bus, a controller area network (CAN) bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local bus (VLB), or another suitable bus or a combination of two or more of these. Bus 1360 may include one or more buses 1360, where appropriate.

In particular embodiments, various modules, circuits, systems, methods, or algorithm steps described in connection with the implementations disclosed herein may be implemented as electronic hardware, computer software, or any suitable combination of hardware and software. In particular embodiments, computer software (which may be referred to as software, computer-executable code, computer code, a computer program, computer instructions, or instructions) may be used to perform various functions described or illustrated herein, and computer software may be configured to be executed by or to control the operation of computer system 1300. As an example, computer software may include instructions configured to be executed by processor 1310. In particular embodiments, owing to the interchangeability of hardware and software, the various illustrative logical blocks, modules, circuits, or algorithm steps have been described generally in terms of functionality. Whether such functionality is implemented in hardware, software, or a combination of hardware and software may depend upon the particular application or design constraints imposed on the overall system.

In particular embodiments, a computing device may be used to implement various modules, circuits, systems, methods, or algorithm steps disclosed herein. As an example, all or part of a module, circuit, system, method, or algorithm disclosed herein may be implemented or performed by a general-purpose single- or multi-chip processor, a digital signal processor (DSP), an ASIC, a FPGA, any other suitable programmable-logic device, discrete gate or transistor logic, discrete hardware components, or any suitable combination thereof. A general-purpose processor may be a microprocessor, or, any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

In particular embodiments, one or more implementations of the subject matter described herein may be implemented as one or more computer programs (e.g., one or more modules of computer-program instructions encoded or stored on a computer-readable non-transitory storage medium). As an example, the steps of a method or algorithm disclosed herein may be implemented in a processor-executable software module which may reside on a computer-readable non-transitory storage medium. In particular embodiments, a computer-readable non-transitory storage medium may include any suitable storage medium that may be used to store or transfer computer software and that may be accessed by a computer system. Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs (e.g., compact discs (CDs), CD-ROM, digital versatile discs (DVDs), blu-ray discs, or laser discs), optical disc drives (ODDs), magneto-optical discs, magneto-optical drives, floppy diskettes, floppy disk drives (FDDs), magnetic tapes, flash memories, solid-state drives (SSDs), RAM, RAM-drives, ROM, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

In particular embodiments, certain features described herein in the context of separate implementations may also be combined and implemented in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variations of a sub-combination.

While operations may be depicted in the drawings as occurring in a particular order, this should not be understood as requiring that such operations be performed in the particular order shown or in sequential order, or that all operations be performed. Further, the drawings may schematically depict one more example processes or methods in the form of a flow diagram or a sequence diagram. However, other operations that are not depicted may be incorporated in the example processes or methods that are schematically illustrated. For example, one or more additional operations may be performed before, after, simultaneously with, or between any of the illustrated operations. Moreover, one or more operations depicted in a diagram may be repeated, where appropriate. Additionally, operations depicted in a diagram may be performed in any suitable order. Furthermore, although particular components, devices, or systems are described herein as carrying out particular operations, any suitable combination of any suitable components, devices, or systems may be used to carry out any suitable operation or combination of operations. In certain circumstances, multitasking or parallel processing operations may be performed. Moreover, the separation of various system components in the implementations described herein should not be understood as requiring such separation in all implementations, and it should be understood that the described program components and systems may be integrated together in a single software product or packaged into multiple software products.

Various embodiments have been described in connection with the accompanying drawings. However, it should be understood that the figures may not necessarily be drawn to scale. As an example, distances or angles depicted in the figures are illustrative and may not necessarily bear an exact relationship to actual dimensions or layouts of the devices illustrated.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes or illustrates respective embodiments herein as including particular components, elements, functions, operations, or steps, any of these embodiments may include any combination or permutation of any of the components, elements, functions, operations, or steps described or illustrated anywhere herein that a person having ordinary skill in the art would comprehend.

The term “or” as used herein is to be interpreted as an inclusive or meaning any one or any combination, unless expressly indicated otherwise or indicated otherwise by context. Therefore, herein, the expression “A or B” means “A, B, or both A and B.” As another example, herein, “A, B or C” means at least one of the following: A; B; C; A and B; A and C; B and C; A, B and C. An exception to this definition will occur if a combination of elements, devices, steps, or operations is in some way inherently mutually exclusive.

As used herein, words of approximation such as, without limitation, “approximately, “substantially,” or “about” refer to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skill in the art recognize the modified feature as having the required characteristics or capabilities of the unmodified feature. In general, but subject to the preceding discussion, a numerical value herein that is modified by a word of approximation such as “approximately” may vary from the stated value by ±0.5%, ±1%, ±2%, 3%, ±4%, ±5%, ±10%, ±12%, or ±15%. The term “substantially constant” refers to a value that varies by less than a particular amount over any suitable time interval. For example, a value that is substantially constant may vary by less than or equal to 20%, 10%, 1%, 0.5%, or 0.1% over a time interval of approximately 10⁴ s, 10³ s, 10² s, 10 s, 1 s, 100 ms, 10 ms, 1 ms, 100 μs, 10 μs, or 1 μs. The term “substantially constant” may be applied to any suitable value, such as for example, an optical power, a pulse repetition frequency, an electrical current, a wavelength, an optical or electrical frequency, or an optical or electrical phase.

As used herein, the terms “first,” “second,” “third,” etc. may be used as labels for nouns that they precede, and these terms may not necessarily imply a particular ordering (e.g., a particular spatial, temporal, or logical ordering). As an example, a system may be described as determining a “first result” and a “second result,” and the terms “first” and “second” may not necessarily imply that the first result is determined before the second result.

As used herein, the terms “based on” and “based at least in part on” may be used to describe or present one or more factors that affect a determination, and these terms may not exclude additional factors that may affect a determination. A determination may be based solely on those factors which are presented or may be based at least in part on those factors. The phrase “determine A based on B” indicates that B is a factor that affects the determination of A. In some instances, other factors may also contribute to the determination of A. In other instances, A may be determined based solely on B.

Although the foregoing embodiments have been described in some detail for purposes of clarity of understanding, the invention is not limited to the details provided. There are many alternative ways of implementing the invention. The disclosed embodiments are illustrative and not restrictive.

1. A system, comprising:
a light source configured to emit a light pulse;
a radar transmitter configured to transmit a radar signal, wherein an emission direction of the light pulse of the light source and a transmission direction of the radar signal of the radar transmitter are at least in part synchronized;
a light receiver configured to detect a reflected light pulse;
a radar receiver configured to detect a reflected radar signal; and
a processor configured to determine a dimensional representation of an environment based at least in part on the detected reflected light pulse and the detected reflected radar signal.

2. The system of claim 1, further comprising a dual mode scanner configured to:
receive the light pulse of the light source and the radar signal of the radar transmitter; and
direct the emission direction of the light pulse and the transmission direction of the radar signal.

3. The system of claim 2, wherein the dual mode scanner includes a polygon mirror and a scan mirror, wherein the polygon mirror is configured to:
receive the light pulse of the light source and the radar signal of the radar transmitter; and
reflect the light pulse of the light source and the radar signal of the radar transmitter at the scan mirror along a first axis; and
wherein the scan mirror is configured to:
reflect the received light pulse of the light source in the emission direction of the light pulse along a second axis.

4. The system of claim 3, wherein the scan mirror is further configured to reflect the received radar signal of the radar transmitter along the second axis.

5. The system of claim 3, wherein the scan mirror is further configured to transmit the received radar signal of the radar transmitter.

6. The system of claim 1, wherein the emission direction of the light pulse of the light source and the transmission direction of the radar signal of the radar transmitter are synchronized along a first axis and a second axis.

7. The system of claim 6, wherein the first axis corresponds to an azimuth direction and the second axis corresponds to an elevation direction.

8. The system of claim 1, wherein the emission direction of the light pulse of the light source and the transmission direction of the radar signal of the radar transmitter are synchronized along a first axis and decoupled along a second axis.

9. The system of claim 8, wherein the first axis corresponds to an azimuth direction and the second axis corresponds to an elevation direction.

10. The system of claim 8, wherein the second axis of the emission direction of the light pulse of the light source is mechanically steered and the second axis of the transmission direction of the radar signal of the radar transmitter is electronically steered.

11. The system of claim 10, wherein the mechanical steering of the second axis of the emission direction of the light pulse of the light source is performed at least in part by a scan mirror, wherein the scan mirror includes a first surface that is reflective for light and transmissive for radar and a second surface that is reflective for radar.

12. The system of claim 11, wherein the first surface includes a dichroic coating and the second surface corresponds to a metallic surface.

13. A method, comprising:
emitting a light pulse from a light source;
transmitting a radar signal from a radar transmitter;
using a dual mode scanner to scan the light pulse in an emission direction;
using the dual mode scanner to scan the radar signal in a transmission direction, wherein the emission direction and the transmission direction are at least in part synchronized;
receiving at a light receiver a reflected light pulse;
receiving at a radar receiver a reflected radar signal; and
determining a dimensional representation of an environment based at least in part on the received reflected light pulse and the received reflected radar signal.

14. The method of claim 13, further comprising:
receiving the light pulse of the light source and the radar signal of the radar transmitter at a polygon mirror of the dual mode scanner;
using the polygon mirror to reflect the light pulse of the light source and the radar signal of the radar transmitter at a scan mirror along a first axis; and
using the scan mirror to reflect the received light pulse of the light source in the emission direction of the light pulse along a second axis.

15. The method of claim 14, further comprising using the scan mirror to reflect the received radar signal of the radar transmitter along the second axis.

16. The method of claim 14, further comprising using the scan mirror to transmit the received radar signal of the radar transmitter.

17. The method of claim 13, wherein the emission direction of the light pulse of the light source and the transmission direction of the radar signal of the radar transmitter are synchronized along a first axis and a second axis.

18. The method of claim 13, wherein the emission direction of the light pulse of the light source and the transmission direction of the radar signal of the radar transmitter are synchronized along a first axis and decoupled along a second axis.

19. The method of claim 18, further comprising:
mechanically steering the emission direction of the light pulse of the light source along the second axis; and
electronically steering the transmission direction of the radar signal of the radar transmitter along the second axis.

20. A system, comprising:
a light source configured to emit light;
a radio frequency source configured to transmit radio signals;
a dual mode scanner configured to scan the emitted light across a first field of regard and the transmitted radio signals across a second field of regard;
a light receiver configured to detect a return light pulse corresponding to the emitted light scattered by an external target located downrange to provide a lidar measurement signal;
a radio frequency receiver configured to detect a return radio frequency signal corresponding to the transmitted radio signals scattered by the external target located downrange to provide a radar measurement signal; and
a processor configured to identify the lidar measurement signal and the radar measurement signal as corresponding to the same external target and to determine a fused measurement for the external target based on the lidar measurement signal and the radar measurement signal.
